(19) United States
(12) Patent Application Publication
(10) Pub. No.: US 2026/0323571 A1
(43) Pub. Date: Oct. 15, 2026

(54) Methods and Apparatuses for Handling of a Remote User Equipment for Positioning

(71) Applicant: Telefonaktiebolaget LM Ericsson (publ), Stockholm (SE)

(72) Inventors: Ritesh Shreevastav, Upplands Väsby (SE); Richárd Bátorfi, Budapest (HU); Min Wang, Luleå (SE); Zhang Fu, Stockholm (SE); Mohammed Yazid Lyazidi, London (GB); Liwei Qiu, Täby (SE)

(21) Appl. No.: 19/117,314

(22) PCT Filed: Oct. 3, 2023
(86) PCT No.: PCT/SE2023/050986

§ 371 Date: Mar. 31, 2025

Related U.S. Application Data
(60) Provisional application No. 63/414,653, filed on Oct. 10, 2022.

(51) Int. Cl. H04W 64/00; H04W 92/18

(52) U.S. Cl. CPC H04W 64/00; H04W 92/18

(57) ABSTRACT

Embodiments described herein relate to methods and apparatuses for assisting in determining positioning of a remote user equipment that is communicating with a network via sidelink, SL, communication. A method in an Access and Mobility Management Function, AMF, comprises receiving a first request for positioning information associated with the remote UE from a Gateway Mobile Location Centre, GMLC; and transmitting a first response to the first request, wherein the first response comprises: an indication of a location of the remote UE to the GMLC, and an indication that the remote UE is connecting to the network via the relay UE.

### TECHNICAL FIELD

Embodiments described herein relate to methods and apparatuses for handling of a remote user equipment (UE) for positioning.

### BACKGROUND

Positioning has been a topic in Long Term Evolution (LTE) standardization since the 3^{rd} Generation Partnership Project (3GPP) Release 9. The primary objective is to fulfill regulatory requirements for emergency call positioning. Positioning in New Radio (NR) is proposed to be supported by the architecture shown in Error! Reference source not found. In particular, FIG. 1 illustrates Next Generation Radio Access Network (NG-RAN) Rel-15 Location Services (LCS) Protocols. The Location Management Function (LMF) is the location node in New Radio (NR). There are also interactions between the location node and the gNodeB via the NR Position Protocol a (NRPPa) protocol (see for example, TS 38.455 v17.2.0). The interactions between the gNodeB and the device may be supported via the Radio Resource Control (RRC) protocol.

In the legacy LTE standards, the following techniques are supported:
Enhanced Cell ID—Essentially cell identification (ID) information to associate the device to the serving area of a serving cell, and then additional information to determine a finer granularity position;
Assisted Global Navigation Satellite System (GNSS)—GNSS information retrieved by the device, supported by assistance information provided to the device from Enhanced Serving Mobile Location Center (E-SMLC);
OTDOA (Observed Time Difference of Arrival)—The device estimates the time difference of reference signals from different base stations and sends to the E-SMLC for multilateration;
UTDOA (Uplink TDOA)—The device is requested to transmit a specific waveform that is detected by multiple location measurement units (e.g. an eNB) at known positions. These measurements are forwarded to E-SMLC for multilateration; and
Sensor methods such as Biometric pressure sensor which provides vertical position of the device and Inertial Motion Unit (IMU) which provides displacement.

NR supports below Radio Access Technology (RAT) Dependent positioning methods:

### Downlink (DL)—Time Difference of Arrival (TDOA):

The DL TDOA positioning method makes use of the DL Reference Signal Time Difference (RSTD) (and optionally DL PRS RSRP) of downlink signals received from multiple Transmission Points (TPs), at the UE. The UE measures the DL RSTD (and optionally DL Positioning Reference Signal (PRS) Reference Signal Received Power (RSRP)) of the received signals using assistance data received from the positioning server, and the resulting measurements are used along with other configuration information to locate the UE in relation to the neighbouring Transmission/Reception Points (TRPs).

Multi-Round Trip Time (RTT): The Multi-RTT positioning method makes use of the UE Rx-Tx measurements and DL PRS RSRP of downlink signals received from multiple TRPs, measured by the UE and the measured gNB Rx-Tx measurements and UL Sounding Reference Signal (SRS)-RSRP at multiple TRPs of uplink signals transmitted from UE.

### Uplink (UL)—TDOA:

The UL TDOA positioning method makes use of the UL TDOA (and optionally UL SRS-RSRP) at multiple Reception Points (RPs) of uplink signals transmitted from UE. The RPs measure the UL TDOA (and optionally UL SRS-RSRP) of the received signals using assistance data received from the positioning server, and the resulting measurements are used along with other configuration information to estimate the location of the UE.

### DL—Angle of Depature (AoD):

The DL AoD positioning method makes use of the measured DL PRS RSRP of downlink signals received from multiple Transmission Points (TPs), at the UE. The UE measures the DL PRS RSRP of the received signals using assistance data received from the positioning server, and the resulting measurements are used along with other configuration information to locate the UE in relation to the neighbouring Transmission Points (TPs).

UL—Angle of Arrival (AoA):

The UL AoA positioning method makes use of the measured azimuth and zenith of arrival at multiple Reception Points (RPs) of uplink signals transmitted from the UE. The RPs measure the Azimuth AoA (A-AoA) and zenith AoA (Z-AoA) of the received signals using assistance data received from the positioning server, and the resulting measurements are used along with other configuration information to estimate the location of the UE.

### NR-ECID:

NR Enhanced Cell ID (NR E-CID) positioning refers to techniques which use additional UE measurements and/or NR radio resource and other measurements to improve the UE location estimate.

The positioning modes can be categorized in below three areas:
UE-Assisted: The UE performs measurements with or without assistance from the network and sends these measurements to the E-SMLC where the position calculation may take place.
UE-Based: The UE performs measurements and calculates its own position with assistance from the network.
Standalone: The UE performs measurements and calculates its own position without network assistance.
   Sidelink Transmissions in NR (e.g. As Described in TS 23.304 17.4.0)

3GPP specified the LTE D2D (device-to-device) technology, also known as ProSe (Proximity Services) in the Release 12 and 13 of LTE. Later in Rel. 14 and 15, LTE Vehicle-to-everything (V2X) related enhancements targeting the specific characteristics of vehicular communications were specified. 3GPP has started a new work item (WI) in August 2018 within the scope of Rel. 16 to develop a new radio (NR) version of V2X communications. The NR V2X mainly targets advanced V2X services, which can be categorized into four use case groups: vehicles platooning, extended sensors, advanced driving and remote driving. The advanced V2X services may require enhanced NR system and new NR sidelink framework to meet the stringent requirements in terms of latency and reliability. NR V2X system also expects to have higher system capacity and better coverage and to allow for an easy extension to support the future development of further advanced V2X services and other services.

Given the targeted services by NR V2X, it is commonly recognized that groupcast/multicast and unicast transmissions are desired, in which the intended receiver of a message consists of only a subset of the vehicles in proximity to the transmitter (groupcast) or of a single vehicle (unicast). For example, in the platooning service there are certain messages that may only be of interest of the members of the platoon, making the members of the platoon a natural groupcast. In another example, the see-through use case most likely involves only a pair of vehicles, for which unicast transmissions naturally fit. Therefore, NR sidelink can support broadcast (as in LTE), groupcast and unicast transmissions. Furthermore, NR sidelink is designed in such a way that its operation is possible with and without network coverage and with varying degrees of interaction between the UEs (user equipment) and the NW (network), including support for standalone, network-less operation.

In 3GPP Rel. 17, discussions took place and National Security and Public Safety (NSPS) is considered to be one important use case, which can benefit from the already developed NR sidelink features in Rel. 16. Therefore, it is most likely that 3GPP will specify enhancements related to NSPS use case taking NR Rel. 16 sidelink as a baseline. Besides, in some scenarios NSPS services need to operate with partial or w/o NW coverage, such as indoor firefighting, forest firefighting, earthquake rescue, sea rescue, etc. where the infrastructure is (partially) destroyed or not available, therefore, coverage extension is a crucial enabler for NSPS, for both NSPS services communicated between UE and cellular NW and that communicated between UEs over sidelink. In Rel. 17, a Study Item Description (SID) on NR sidelink relay (RP-193253) was launched which aims to further explore coverage extension for sidelink-based communication, including both UE to NW relay for cellular coverage extension and UE to UE relay for sidelink coverage extension. In the normative phase, only UE to NW relay is considered (see RP-210893, “New WID on NR Sidelink Relay”).

FIG. 2 illustrates UEs in different scenarios.

UEs that are in coverage of a gNB rely on configuration (through RRC and/or System Information Block (SIB)). UEs that are out of coverage rely on a (pre-) configuration available in the Subscriber Identity Module (SIM) of the device. Pre-configuration may be (semi-) static but updates are possible (when the UE is in coverage).

Other UEs may rely on a UE-to-Network relay, for example a L2 UE-to-Network relay.

In the TR 23.752 v 17.0.0 clause 6.7, the layer 2 based UE-to-Network (U2N) relay is described.

The L2 UE-to-Network Relay UE provides forwarding functionality that can relay any type of traffic over the PC5 link.

The L2 UE-to-Network Relay UE provides the functionality to support connectivity to the 5GS for Remote UEs. A UE is considered to be a Remote UE if it has successfully established a PC5 link to the L2 UE-to-Network Relay UE. A Remote UE can be located within NG-RAN coverage or outside of NG-RAN coverage.

FIG. 3 illustrates the protocol stack for the user plane transport, related to a Packet Data Unit (PDU) Session, including a Layer 2 (L2) UE-to-Network Relay UE. The PDU layer corresponds to the PDU carried between the Remote UE and the Data Network (DN) over the PDU session. The PDU layer corresponds to the PDU carried between the Remote UE and the Data Network (DN) over the PDU session. It is important to note that the two endpoints of the Packet Data Convergence Protocol (PDCP) link are the Remote UE and the gNB. The relay function is performed below Packet Data Convergence Protocol (PDCP). This means that data security is ensured between the Remote UE and the gNB without exposing raw data at the UE-to-Network Relay UE.

The adaptation relay layer within the UE-to-Network Relay UE can differentiate between signalling radio bearers (SRBs) and data radio bearers (DRBs) for a particular Remote UE. The adaption relay layer is also responsible for mapping PC5 traffic to one or more DRBs of the Uu. The definition of the adaptation relay layer is under the responsibility of RAN WG2.

FIG. 4 illustrates the protocol stack of the Non-Access Stratum (NAS) connection for the Remote UE to the Non Access Stratum Mobility Management (NAS-MM) and Non Access Stratum Session Management (NAS-SM) components. The NAS messages are transparently transferred between the Remote UE and 5G-AN over the Layer 2 UE-to-Network Relay UE using:
PDCP end-to-end connection where the role of the UE-to-Network Relay UE is to relay the PDUs over the signalling radio bear without any modifications.
N2 connection between the 5G-AN and AMF over N2.
N3 connection AMF and SMF over N11.

The role of the UE-to-Network Relay UE is to relay the PDUs from the signaling radio bearer without any modifications.

### Zone Configuration in SL

As described in clause 5.2.2.2.1 of TR 37.985 v 17.1.1, cellular networks are designed to support resource re-use over a given geographical area, to manage interference and improve area spectral efficiency. A similar concept is available in LTE-V2X. LTE-V2X can optionally divide the world into zones (e.g. geographical areas), which have a (pre-) configurable width and height. Nearby zones are assigned different resource pools, with spatially-periodic re-use over a distance controlled by the zone width and height. A UE performs transmission using the resource pool(s) associated with its current zone, for mode 4. FIG. 5 shows an example of the configuration of zones, where those with the same zone_id use the same transmission resource pools.

In particular, FIG. 5 illustrates a UE location as x′=ceil (x/L) mod Nₓ; y′=ceil (y/W) mod N_{y}; zone_id=y′×Nₓ+x′; where x and y are the longitude and latitude of the UE's location, L, W are the length and width of each zone, respectively, and Nₓ, N_{y} are the number of zones in length and width respectively in TR 37.985 V 17.1.1.

Further, as described in clause 5.8.11 of TS 38.331 v 17.2.0, the UE may determine an identity of the zone (i.e. Zone_id) in which it is located using the following formulae, if sl-ZoneConfig is configured:

x₁=Floor(x/L)Mod 64;

y₁=Floor(y/L)Mod 64;

Zone_id=y₁*64+x₁.

The parameters in the formulae are defined as follows:
L is the value of sl-ZoneLength included in sl-ZoneConfig;
x is the geodesic distance in longitude between UE's current location and geographical coordinates (0, 0) according to World Geodetic System, WGS84, model and it is expressed in meters;
y is the geodesic distance in latitude between UE's current location and geographical coordinates (0, 0) according to WGS84 model and it is expressed in meters.

NOTE: How the calculated zone_id is used is specified in TS 38.321 v17.2.0.

### SUMMARY

There currently exist certain challenge(s).

3GPP needs to specify the procedure/mechanism for sidelink based positioning. For SL based positioning, a UE which may not have cellular coverage may also need to be supported for positioning. In such case, NW may provide sidelink configuration (pre-configured configuration) to the UEs which may assist in performing sidelink positioning. However, there would be scenarios where either the NW or the UE do not support sidelink positioning. In such case, basic positioning may still need to be provided.

For a UE (e.g., remote UE) which has no cellular coverage and connects to the gNB via a relay UE (NWrelayUE), the remote UE may neither be able to measure the Dowlink (DL) Positioning Reference Signal (PRS) transmitted by the gNB nor transmit a Sounding Reference Signal (SRS) towards the gNB since the remote UE may not be able to perform the normal Radio Access Technology (RAT) dependent positioning because it may not hear the DL positioning reference signal and similarly its uplink reference signal for positioning may not be heard by gNB.

Considering for example NR Enhanced cell ID (NR E-CID) based positioning; the remote UE may provide the serving cell ID via help of relay UE/functionality. However, it would be misleading if LMF is unaware that UE is remote UE. There is a risk that LMF would assume that the remote UE is within the coverage of its serving cell. A large UE location error would persist in such case.

When an external client or UE LCS client request for positioning; there is no information that is provided which would suggest that the remote UE is out of cellular coverage and the positioning computation may be unreliable.

Currently the Access and Mobility Management Function (AMF) returns the Namf_Location_ProvidePositioningInfo Response towards the (Visitor) Gateway Mobile Location Centre (GMLC) (or Home GMLC (HGMLC) for roaming when the NL3 reference point, which supports location requests forwarded by an HGMLC to a VGMLC, is not supported) to return the current location of the UE. The service operation includes the location estimate, its age and accuracy and may include information about the positioning method and the timestamp of the location estimate. Based on stage 3 specification (e.g. TS 29.518 17.6.0) the AMF may provide the cell ID to the GMLC. This may then result in the GMLC and the Location Services (LCS) client assuming that the remote UE is in cell coverage. However, this would be incorrect since remote UE is attached to a NW-relay-UE and not to the base station (gNB) directly.

Certain aspects of the disclosure and their embodiments may provide solutions to these or other challenges. In embodiments described herein an efficient signaling mechanism is defined between the AMF and a GMLC to indicate that the UE is a remote UE. A geographical area description (GAD) shape may then be defined that comprises an extended area (i.e serving cell+area outside of cellular coverage). In some embodiments, the area outside of cellular coverage may be marked as zones for sidelink/relay operation. Hence, the reporting may comprise an indication that UE is remote UE and has GAD based upon extended serving cell ID. The positioning procedure may comprise reporting cellID+relay extension.

According to some embodiments there is provided a method performed by an Access and Mobility Management Function, AMF, for assisting in determining positioning of a remote user equipment, UE that is communicating with a network via sidelink, SL, communication with a relay UE. The method comprises receiving a first request for positioning information associated with the remote UE from a Gateway Mobile Location Centre, GMLC; and transmitting a first response to the first request, wherein the first response comprises: an indication of a location of the remote UE to the GMLC, and an indication that the remote UE is connecting to the network via the relay UE.

According to some embodiments there is provided a method performed by a Gateway Mobile Location Centre, GMLC, for assisting in determining positioning of a remote user equipment, UE that is communicating with a network via sidelink, SL, communication with a relay UE. The method comprises transmitting a first request for positioning information associated with the remote UE from a Gateway to an Access and Mobility Management Function, AMF; and receiving a first response to the first request, wherein the first response comprises: an indication of a location of the remote UE to the GMLC, and an indication that the remote UE is connecting to the network via the relay UE.

According to some embodiments there is provided a method performed by a Location Management Function, LMF, for assisting in determining positioning of a remote user equipment, UE that is communicating with a network via sidelink, SL, communication with a relay UE. The method comprises receiving a second request, from an Access and Mobility Management Function, AMF, for an indication of a location of the remote UE, wherein the second request comprises an indication that the remote UE is connecting to the network via the relay UE.

According to some embodiments there is provided a method performed by a first user equipment, UE for assisting in determining positioning of a remote user equipment, UE that is communicating with a network via sidelink, SL, communication with a relay UE, wherein the first UE comprises the remote UE or the relay UE. The method comprises transmitting (602), to a base station, an indication of a cell identification for a serving cell serving the relay UE to assist in positioning of the remote UE.

According to some embodiments there is provided a method performed by a network node in a network for assisting in determining positioning of a remote user equipment, UE that is communicating with a network via sidelink, SL, communication with a relay UE. The method comprises receiving (702), from a first UE, an indication of a cell identification for a serving cell serving the relay UE to assist in positioning of the remote UE.

According to some embodiments there is provided an access and mobility management function, AMF, for assisting in determining positioning of a remote user equipment, UE when the UE is communicating with a network via sidelink, SL, communication with a relay UE. The AMF comprises processing and a memory, the memory containing instructions executable by the processing circuitry whereby the AMF is operable to: receive a first request for positioning information associated with the remote UE from a Gateway Mobile Location Centre, GMLC; and transmit a first response to the first request, wherein the first response comprises: an indication of a location of the remote UE to the GMLC, and an indication that the remote UE is connecting to the network via the relay UE.

According to some embodiments there is provided a Location Management Function for assisting in determining positioning of a remote user equipment, UE when the remote UE is communicating with a network via sidelink, SL, communication with a relay UE. The LMF comprises processing circuitry and a memory, the memory containing instructions executable by the processing circuitry whereby the LMF is operable to: receive a second request, from an Access and Mobility Management Function, AMF, for an indication of a location of the remote UE, wherein the second request comprises an indication that the remote UE is connecting to the network via the relay UE.

According to some embodiments there is provided a Gateway Mobile Location Centre, GMLC, for assisting in determining positioning of a remote user equipment, UE when the remote UE is communicating with a network via sidelink, SL, communication with a relay UE. The GMLC comprises processing circuitry and a memory, the memory containing instructions executable by the processing circuitry whereby the GMLC to operable to: transmit a first request for positioning information associated with the remote UE from a Gateway to an Access and Mobility Management Function, AMF; and receive a first response to the first request, wherein the first response comprises: an indication of a location of the remote UE to the GMLC, and an indication that the remote UE is connecting to the network via the relay UE.

According to some embodiments there is provided a first user equipment for assisting in determining positioning of a remote user equipment, UE when the remove UE is communicating with a network via sidelink, SL, communication with a relay UE, wherein the first UE comprises the remote UE or the relay UE. The first UE comprises processing and a memory, the memory containing instructions executable by the processing circuitry whereby the user equipment is operable to: transmit (602), to a base station, an indication of a cell identification for a serving cell serving the relay UE to assist in positioning of the remote UE.

According to some embodiments there is provided a network node for assisting in determining positioning of a remote user equipment, UE when the remote UE is communicating with a network via sidelink, SL, communication with a relay UE. The network node comprises processing circuitry and a memory, the memory containing instructions executable by the processing circuitry whereby the network node is operable to: receive (702), from a first UE, an indication of a cell identification for a serving cell serving the relay UE to assist in positioning of the remote UE.

According to some embodiments there is provided a computer program, comprising instructions which, when executed on at least one processor, cause the at least one processor to carry out any of the methods described above.

According to some embodiments there is provided a carrier containing the computer program as described above, wherein the carrier comprises one of an electronic signal, optical signal, radio signal or computer readable storage medium.

According to some embodiments there is provided a computer-readable medium comprising instructions that, when executed on at least one processor, cause the at least one processor to perform any of the methods described above.

According to some embodiments there is provided a computer program product comprising non transitory computer readable media having stored thereon a computer program as described above.

The embodiments described herein thereby allow a client to be aware that the UE is reachable by means of relay UE only. The mechanism allows the GMLC to understand that the provided location may be unreliable.

The embodiments described herein also provide an observability mechanism to operators to see what percentage of UEs are out of coverage and require positioning support. This may help them to identify where more Network (NW) nodes such as base stations may be required or to enable Sidelink based functionality to improve positioning.

In particular, embodiments described herein provide a method performed by an AMF to inform a GMLC that a remote UE is out of coverage of the cellular network and that therefore positioning obtained is not reliable.

Certain embodiments may provide one or more of the following technical advantage(s). Informing client that the cellular positioning may be unreliable and that other enhancements such as Sidelink positioning may be required.

To provide best effort positioning by providing the remote UE cell ID and indicating that the UE is a remote UE.

In case when no LMF is deployed; the AMF may notify a GMLC that UE is out of cellular coverage (remote UE) and can be connected only using relay UE.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 illustrates NG-RAN Rel-15 LCS Protocols;

FIG. 2 illustrates UEs in different scenarios;

FIG. 3 illustrates the protocol stack for the user plane transport, related to a PDU Session, including a Layer 2 UE-to-Network Relay UE;

FIG. 4 illustrates the protocol stack of the Non-Access Stratum (NAS) connection for the Remote UE to the NAS-MM and NAS-SM components;

FIG. 5 shows an example of the configuration of zones;

FIG. 6 shows a method performed by a wireless device according to embodiments of the disclosure;

FIG. 7 shows a method performed by a network node according to embodiments of the disclosure;

FIG. 8 shows a method performed by a second core network entity according to embodiments of the disclosure;

FIG. 9 depicts a method in accordance with particular embodiments.

FIG. 10 depicts a method in accordance with particular embodiments.

FIG. 11 is a tabular example of signalling the cell IDs and information

FIG. 12 illustrates general network positioning for the LCS clients external to the Public Land Mobile Network (PLMN) for the regulatory location service for non-roaming scenario;

FIG. 13 illustrates a general network positioning requested by the LCS clients or the Application function;

FIG. 14 shows an example of a communication system in accordance with some embodiments;

FIG. 15 shows a UE in accordance with some embodiments;

FIG. 16 shows a network node in accordance with some embodiments;

FIG. 17 is a block diagram of a host in accordance with various aspects described herein;

FIG. 18 is a block diagram illustrating a virtualization environment in which functions implemented by some embodiments may be virtualized;

FIG. 19 shows a communication diagram of a host communicating via a network node with a UE over a partially wireless connection in accordance with some embodiments; and

FIG. 20 shows a network node in accordance with further embodiments.

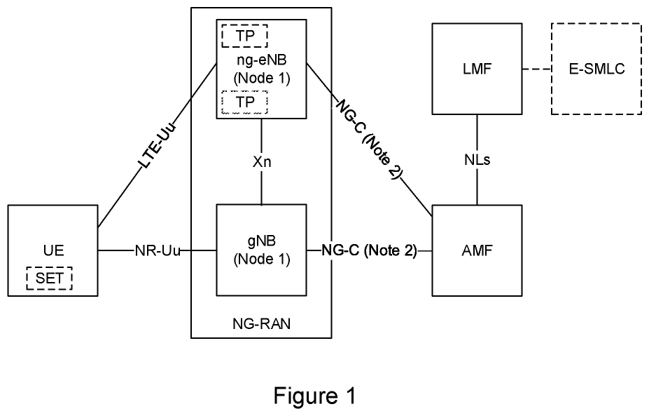

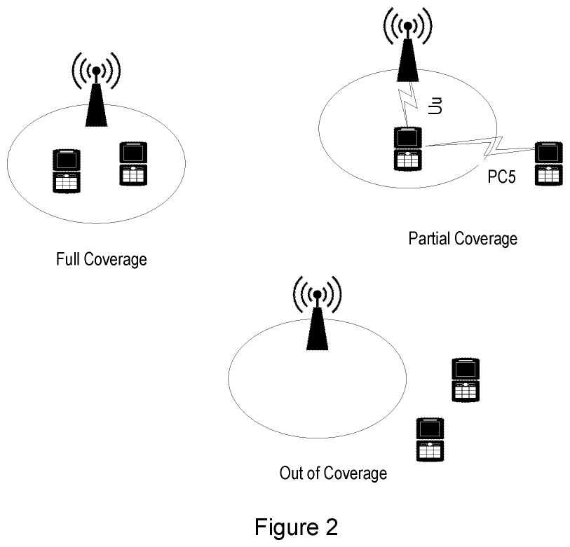

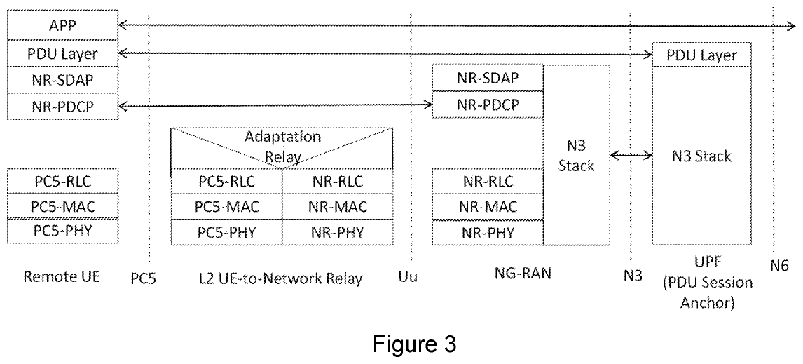

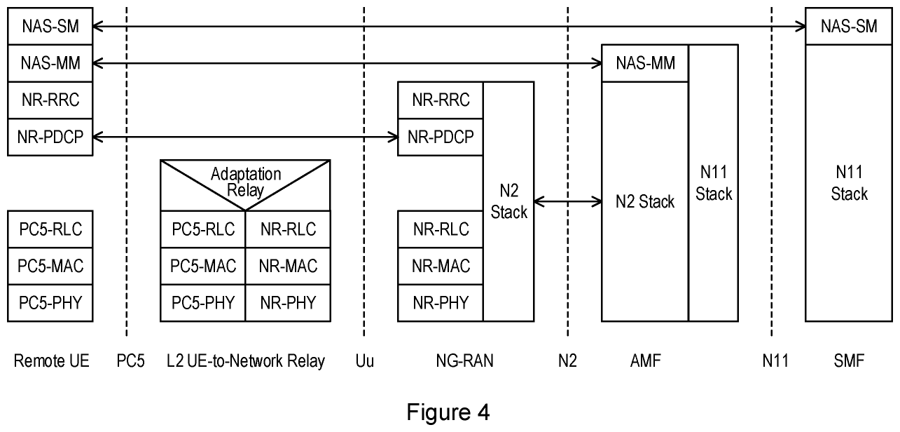

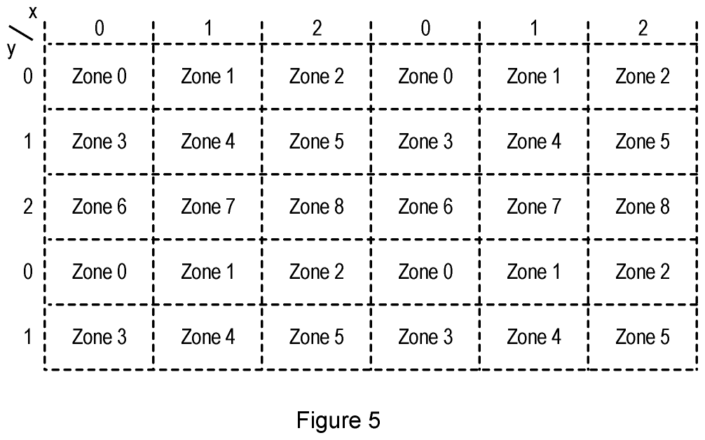

### DETAILED DESCRIPTION

Some of the embodiments contemplated herein will now be described more fully with reference to the accompanying drawings. Embodiments are provided by way of example to convey the scope of the subject matter to those skilled in the art.

The embodiments described herein may be applicable to relay scenarios, for example, including a UE to network relay where the remote UE and the relay UE may be based on LTE sidelink or NR sidelink, and the Uu connection between the relay UE and the base station may be LTE Uu or NR Uu.

The embodiments described herein may be applicable to L2 based user equipment to network (U2N) relay scenarios. The term “remote UE” and the term “target UE” are used interchangeably without loss of the meaning. The remote UE and the relay UE may be served in the same cell. In other words, the remote UE's serving cell and the relay UE's serving cell may be the same.

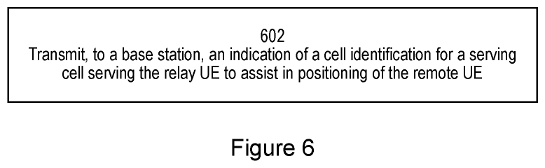

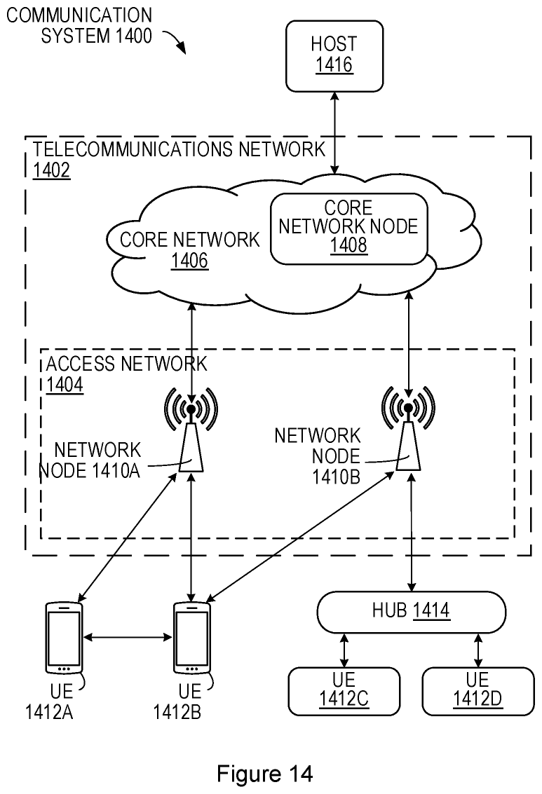

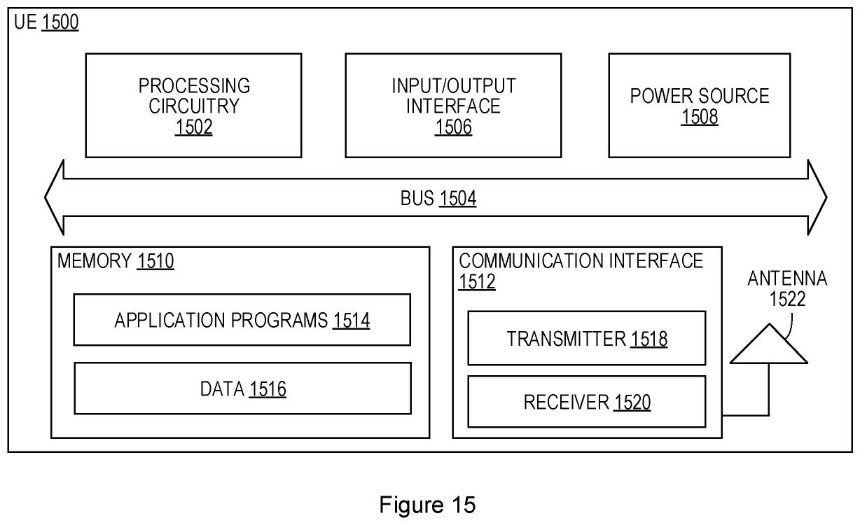

FIG. 6 depicts a method in accordance with particular embodiments. The method 6 may be performed by a UE or wireless device (e.g. the UE 1412 or UE 1500 as described later with reference to FIGS. 14 and 15 respectively). The method of FIG. 6 may be performed by a first user equipment for assisting in determining positioning of a remote user equipment, UE that is communicating with a network via sidelink, SL, communication with a relay UE. The first UE may comprise the relay UE or the remote UE. The method begins at step 602 with transmitting, to a base station, an indication of a cell identification for a serving cell serving the relay UE to assist in positioning of the remote UE.

Where first UE comprises the remote UE, step 602 comprises transmitting the indication to the base station via the relay UE.

In some embodiments the method further comprises transmitting information relating to the sidelink communication between the relay UE and the remote UE to the base station.

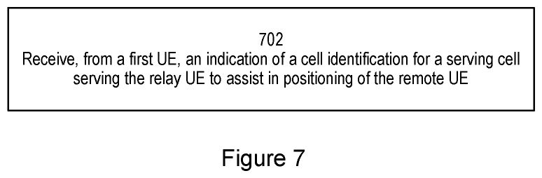

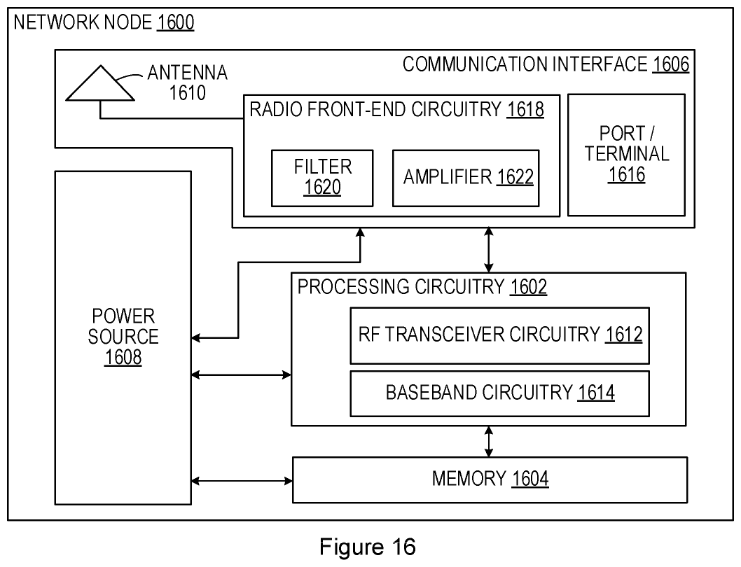

FIG. 7 depicts a method in accordance with particular embodiments. The method of FIG. 7 may be performed by a network node (e.g. the network node 1410 or network node 1600 as described later with reference to FIGS. 14 and 16 respectively). The method may be performed by a network node in a network for assisting in determining positioning of a remote user equipment, UE that is communicating with a network via sidelink, SL, communication with a relay UE. The method begins at step 702 with receiving from a first UE an indication of a cell identification for a serving cell serving the relay UE to assist in positioning of the remote UE. The first UE may comprise the relay UE or the remote UE. Where the first UE comprises the remote UE step 702 may comprise receiving the indication via the relay UE.

The method of 7 may further comprise receiving information relating to the sidelink communication between the relay UE and the remote UE from the first UE.

The method of 7 may further comprise forwarding, to an AMF, the indication of the cell identification for the serving cell serving the relay UE. The method of 7 may further comprise further forwarding the information relating to the sidelink communication between the relay UE and the remote UE to the AMF.

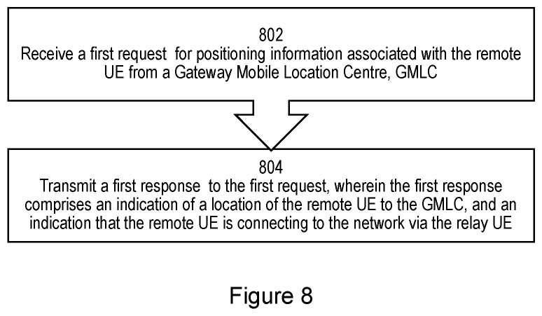

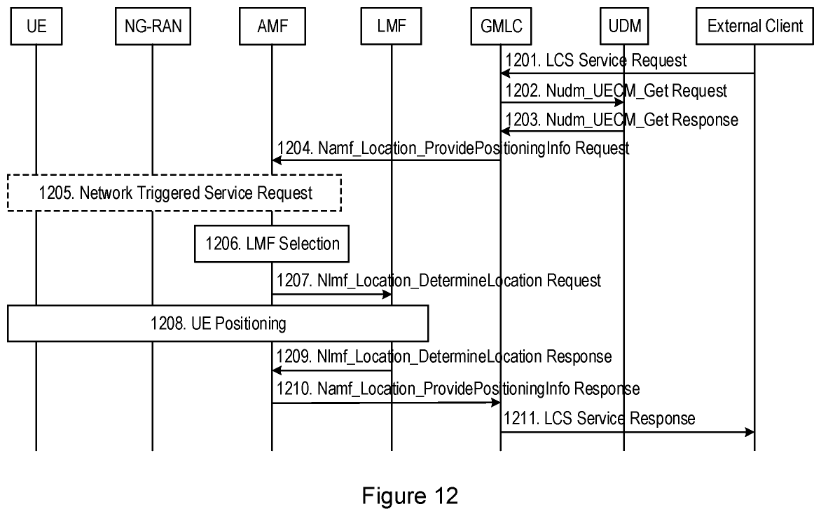

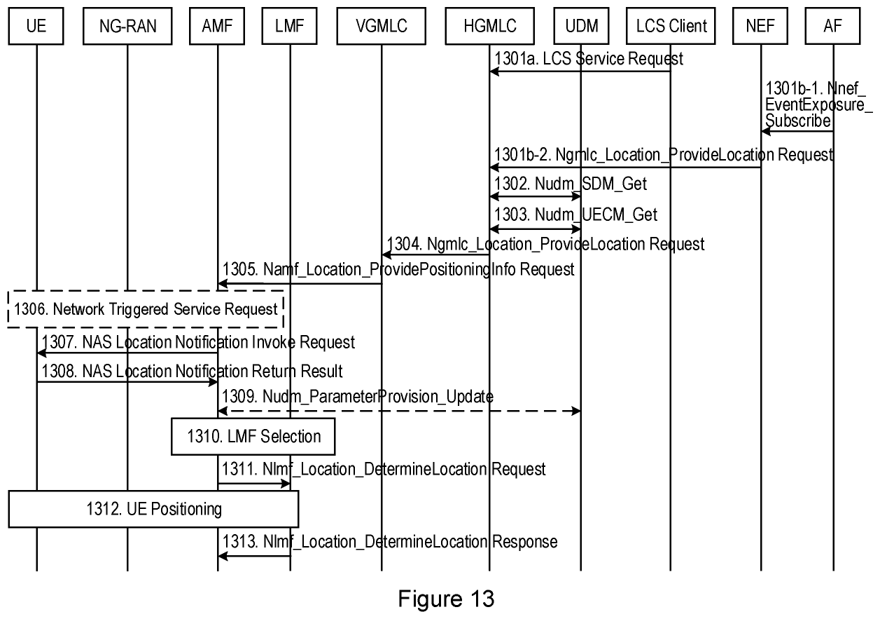

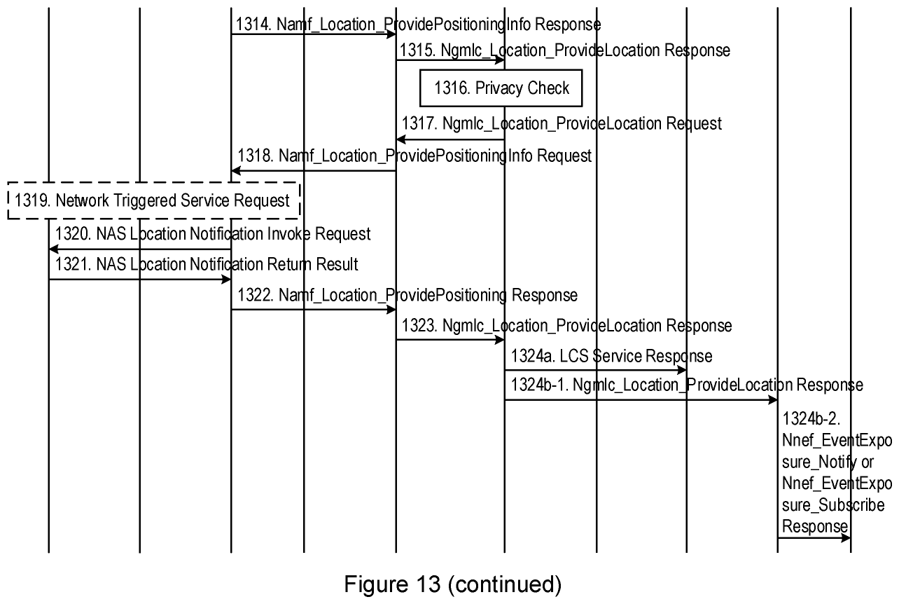

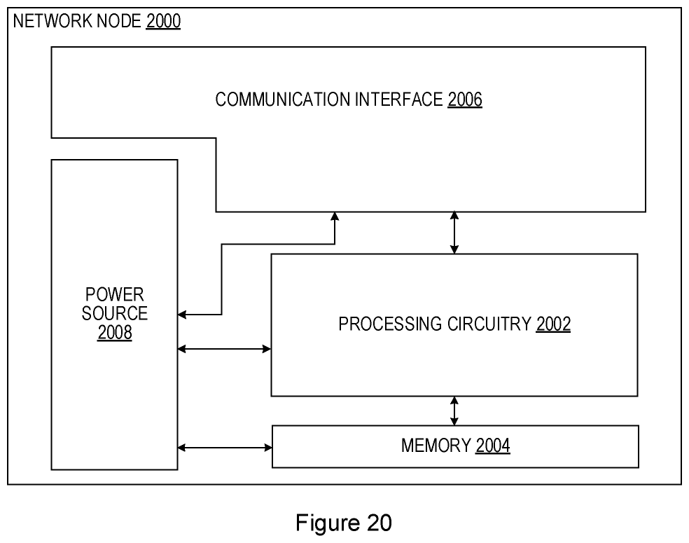

FIG. 8 depicts a method in accordance with particular embodiments. The method of FIG. 8 may be performed by a core network node (e.g. the core network node 1408 or network node 2000 as described later with reference to FIGS. 14 and 20 respectively). The method may be performed by an Access and Mobility Management Function, AMF, for assisting in determining positioning of a remote user equipment, UE, that is communicating with a network via sidelink, SL, communication with a relay UE. The method begins at step 802 with receiving a first request (e.g. Namf-Location_ProvidePositioningInfo Request as illustrated later in FIGS. 12 and 13) for positioning information associated with the remote UE from a Gateway Mobile Location Centre, GMLC. In step 804 the method comprises transmitting a first response (e.g. Namf_Location_ProvidePositioningInfo Response as described later with reference to FIGS. 12 and 13) to the first request, wherein the first response comprises: an indication of a location of the remote UE to the GMLC, and an indication that the remote UE is connecting to the network via the relay UE.

In some embodiments the method of FIG. 8 comprises, responsive to receiving the first request for positioning information, transmitting, to a location management function, LMF, a second request (e.g. Nlmf_Location_DetermineLocation Request as described later with reference to FIGS. 12 and 13) for an indication of a location of the remote UE, wherein the second request comprises an indication that the remote UE is connecting to the network via the relay UE.

In some embodiments the method of FIG. 8 further comprises, responsive to transmitting the second request, receiving the indication of the location of the remote UE (E.g. inNlmf_Location_DetermineLocation Response as described later with reference to FIGS. 12 and 13).

The method of FIG. 8 may further comprise transmitting, to the GMLC, an indication of a cell identification for a serving cell serving the relay UE.

The method of FIG. 8 may further comprise transmitting information to the GMLC relating to the sidelink communication between the relay UE and the remote UE. The information may be received from a base station in a radio access network. The AMF may also receive an indication that the remote UE is connecting to the network via the relay UE from the base station.

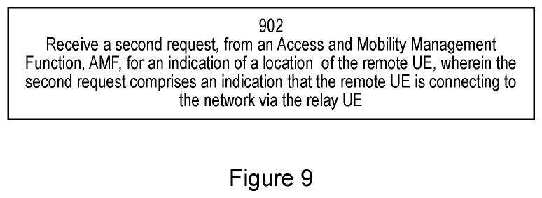

FIG. 9 depicts a method in accordance with particular embodiments. The method of FIG. 9 may be performed by a core network node (e.g. the core network node 1408 or network node 2000 as described later with reference to FIGS. 14 and 20 respectively). The method may be performed by a Location Management Function, LMF, for assisting in determining positioning of a remote user equipment, UE that is communicating with a network via sidelink, SL, communication with a relay UE. The method begins at step 902 with receiving a second request (e.g. Nimf_Location_DetermineLocation Request as described later with reference to FIGS. 12 and 13), from an Access and Mobility Management Function, AMF, for an indication of a location of the remote UE, wherein the second request comprises an indication that the remote UE is connecting to the network via the relay UE.

The LMF may then perform positioning of the remote UE based on the indication that the remote UE is connecting to the network via the relay UE to estimate a location of the remote UE. The LMF may also receive information, from the AMF, relating to the sidelink communication between the relay UE and the remote UE. The positioning of the remote UE may be further based on the received information.

The LMF may then transmit an indication of the estimate of the location of the remote UE to the AMF.

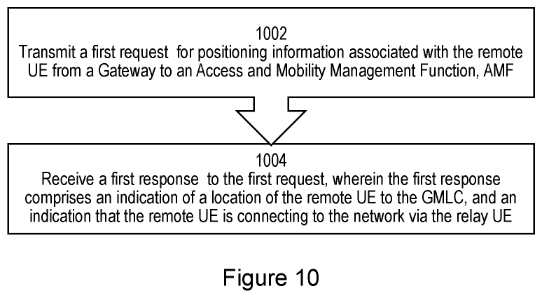

FIG. 10 depicts a method in accordance with particular embodiments. The method of FIG. 10 may be performed by a core network node (e.g. the core network node 1408 or network node 2000 as described later with reference to FIGS. 14 and 20 respectively). The method of FIG. 10 may be performed by a Gateway Mobile Location Centre, GMLC, for assisting in determining positioning of a remote user equipment, UE that is communicating with a network via sidelink, SL, communication with a relay UE. The method begins at step 1002 with transmitting a first request (e.g. Namf-Location_ProvidePositioningInfo Request as described later with reference to FIGS. 12 and 13) for positioning information associated with the remote UE from a Gateway to an Access and Mobility Management Function, AMF. In step 1004 the method comprises receiving a first response (e.g., Namf_Location_ProvidePositioningInfo Response as described later with reference to FIGS. 12 and 13) to the first request, wherein the first response comprises: an indication of a location of the remote UE to the GMLC, and an indication that the remote UE is connecting to the network via the relay UE.

The method may further comprise receiving an indication of a cell identification for the serving cell serving the relay UE from the AMF. The method may further comprise receiving information, from the AMF, relating to the sidelink communication between the relay UE and the remote UE to the base station.

FIGS. 6 to 10 refer to information relating to the sidelink communication between the relay UE and the remote UE.

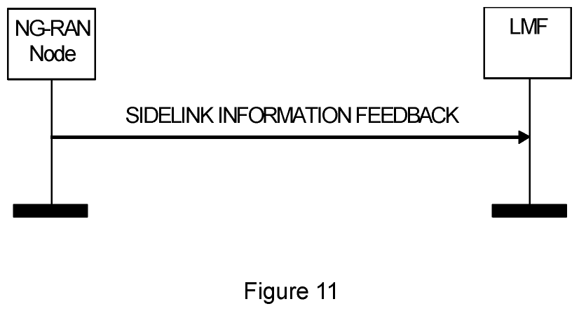

This information may comprise one or more of:
one or more identifications of one or more sidelink resource pools configured for sidelink transmitting and/or reception between the relay UE and the remote UE;
one or more identifications of one or more geographical areas (e.g. zones) associated with each of the one or more sidelink resource pools;
one or more identifications of one or more geographical areas (e.g. zones) that have recently been used for SL transmission or reception. For example, the X (where X is an integer number) most recent zones used for SL transmission or reception, or the zones used for transmission in the recent predetermined time period;
an indication of a maximum coverage distance of the relay UE.
   In one embodiment, the cell ID of the relay UE's serving cell is reported to the LMF (e.g. from the relay UE via a base station and the AMF) for assisting positioning of the remote UE. The report may be performed by the remote UE via the relay UE. Alternatively, the report may be performed by the relay UE on behalf of the remote UE.
   In one embodiment, one or multiple resource pools are configured by the base station (e.g gNB) to the remote UE or the relay UE for SL transmission and/or reception. In this case, information comprising at least one of the following may be reported to LMF (e.g. from the relay UE via a base station and the AMF) for assisting positioning of the remote UE:
Cell ID of the serving cell of the relay UE.
An indication (e.g identifications) of one or more SL resource pools configured for SL transmission or reception
An indication (e.g. identifications) of one or more zones (e.g. geographical areas) associated with each resource pool
An indication (e.g. identifications) of one or more zones (geographical areas) which have recently been used for SL transmission or reception.
   The information may be reported by the remote UE via the relay UE. Alternatively, the information may be reported by the relay UE on behalf of the remote UE.
   The information may be considered by the LMF to improve positioning accuracy for the remote UE.
   The zone and resource mapping information may also be provided to LMF by the base stations (e.g. gNBs), for example, upon request from LMF, using NRPPa (TS 38.455 v 17.2.0) signaling or OAM configuration.
   FIG. 11 is a tabular example of signalling the cell IDs and information (e.g. zone resources used for SL communication) from the gNB to the LMF of the relay UE. Without loss of generality, the message may also be used for signalling general assistance information to support sidelink positioning at LMF.
   The SIDELINK INFORMATION FEEDBACK message may be sent by the base station (e.g. NG-RAN Node) to provide assistance information for sidelink positioning. The following new IE may be included in the SIDELINK INFORMATION FEEDBACK message.

### Direction: NG-RAN Node→LMF.

| | | | IE type and | Semantics |
|---|---|---|---|---|
| IE/Group Name | Presence | Range | reference | description |
| Message Type | M | | 9.2.3 | |
| NRPPa Transaction ID | M | | 9.2.4 | |
| Positioning | | 1 . . . | | The cells |
| sidelink Cells | | <maxnoSLCell> | | associated to the |
| | | | | remote UE |
| | | | | connected via the |
| | | | | U2N Relay |
| >NG-RAN-CGI | M | | 9.2.6 | |
| >resource pool ID | O | | INTEGER(0 . . . N) | |
| >SL Tx zone ID | O | | INTEGER(0 . . . N) | |
| >SL Rx zone ID | O | | INTEGER(0 . . . N) | |

| Range bound | Explanation |
|---|---|
| maxnoSLCells | Maximum no. of cells of the relay UE. |

As illustrated in the table above the sidelink information feedback message comprises a new information element “Positioning sidelink cells” that indicates to the base station “the cells associated to the remote UE connected via the U2N relay”.
In case of a split gNB architecture, the zone and resource mapping information may also be provided to gNB-CU by gNB-DUs, upon request from gNB-DU, using F1AP (TS 38.473 v17.2.0) signaling or OAM configuration.

### Proposed Stage 2 Changes TS 23.273 v 17.6.0

The below text in italics (relating to FIGS. 12 to 13) illustrates changes to TS 23.273 version 17.6.0 according to embodiments described herein. The changes are shown in underline. It will be appreciated that the figures and reference numbers within the figures have been renumbered (when compared to the TS 23.273 document) for clarity, and the sections within curly brackets illustrate steps that correspond to the steps of the embodiments described herein.

### 6.1.1 5GC-MT-LR Procedure for the Regulatory Location Service

FIG. 12 illustrates general network positioning for the LCS clients external to the Public Land Mobile Network (PLMN) for the regulatory location service for non-roaming scenario. In this scenario, it is assumed that the remote UE is identified using a Subscription Permanent Identifier (SUPI) or General Public Subscription Identifier (GPSI).
This procedure is applicable to a request from an LCS client for a current location of the remote UE, and it is assumed that the LCS client is authorised to use the location service and no privacy verification is required.
Step 1201. The external location services client sends a request to the GMLC for a location for the target UE (which may be a remote UE) identified by an GPSI or an SUPI. The request may include the required Quality of Service QoS and Supported GAD shapes. If location is required for more than one UE, the steps following below may be repeated and in that case the GMLC shall verify whether the number of Target UEs in the LCS request is equal to or less than the Maximum Target UE Number of the LCS client. If Maximum Target UE Number is exceeded, the GMLC shall reject the LCS request, the step 1202-1210 are skipped, and then GMLC respond to the client with proper error cause in the step 1211.
Step 1202. The GMLC invokes a Nudm_UECM_Get service operation towards the home UDM of the target UE to be located with the GPSI or SUPI of this UE.
Step 1203. The UDM returns the network addresses of the current serving AMF.
NOTE: For backward compatibility, the GMLC can use a Nudm_SDM_Get service operation to retrieve the SUPI of the target UE from a Rel-15 UDM as defined in TS 23.502 v17.6.0 clause 5.2.3.3.2.
Step 1204. The GMLC invokes the Namf_Location_ProvidePositioningInfo service operation towards the AMF to request the current location of the UE. The service operation may comprise the SUPI, and client type and may include the required QoS and Supported GAD shapes. {Step 1204 corresponds to step 802 of FIG. 8 and step 1002 of FIG. 10.}
Step 1205. If the UE is in CM IDLE state, the AMF may initiate a network triggered Service Request procedure as defined in clause 4.2.3.3 of TS 23.502 v17.6.0 to establish a signalling connection with the UE.
Step 1206. The AMF may select an LMF based on the available information as defined in clause 5.1 or based on AMF local configuration. The LMF selection may take the 5G-AN currently serving the UE into account. The selection may use a Network Repository Function (NRF) query.
Step 1207. The AMF invokes the Nimf_Location_DetermineLocation service operation towards the LMF to request the current location of the UE. The service operation includes a LCS Correlation identifier, the serving cell identity of the Primary Cell in the Master RAN node and the Primary Cell in the Secondary RAN node when available based on Dual Connectivity scenarios, and the client type and may include an indication if UE supports LPP, the required QoS, UE Positioning Capability if available and Supported GAD shapes. If any of the procedures in clause 6.11.1 or clause 6.11.2 are used the service operation includes the AMF identity. If AMF has the information that the UE is connecting to the network via a relay UE, it should include the info in the Nimf_Location_DetermineLocation request to the LMF. {Step 1207 corresponds to step 902 of FIG. 9.}
Step 1208. The LMF performs one or more of the positioning procedures described in clauses 6.11.1, 6.11.2 and 6.11.3. During this step the LMF may use the Namf_Communication_N1N2MessageTransfer service operation to request the transfer of a Positioning related N1 message to the UE or the transfer of a Network Positioning message to the serving NG-RAN node (gNB or NG-eNB) for the UE. The LMF shall determine a geographical location and optionally a location in local coordinates.

### NOTE x: LMF May Consider During Positioning UE is Remote UE or not.

Step 1209. The LMF returns the Nlmf_Location_DetermineLocation Response towards the AMF to return the current location of the UE and UE Positioning Capability if the UE Positioning Capability is received in step 1208 including an indication that the capabilities are non-variable and not received from AMF in step 1207. The service operation includes the LCS Correlation identifier, the location estimate, its age and accuracy and may include information about the positioning method and the timestamp of the location estimate.
Step 1210. The AMF returns the Namf_Location_ProvidePositioningInfo Response towards the GMLC/LRF to return the current location of the UE. The service operation includes the location estimate, its age and accuracy and may include information about the positioning method and the timestamp of the location estimate and if UE is remote UE. The AMF stores the UE Positioning Capability in UE context when received from LMF. {Step 1210 corresponds to step 804 of FIG. 8 and step 1004 of FIG. 10}
Note: The remote UE may also have a serving cell which is same as the relay UE. In case if a relay UE has been determined and the AMF knows the cellID of relay UE. The cell ID and additional information on extended area (such as zones), maximum relay distance are also returned to GMLC. In such cases, the GMLC would consider that the cell is extended implying that the area size could be large with large uncertainty. Either GMLC or LCS client can resolve cellID+relay extension and convert it to GAD shape.
Step 1211. The GMLC sends the location service response to the external location services client.

### 6.1.2 5GC-MT-LR Procedure for the Commercial Location Service

FIG. 13 illustrates a general network positioning requested by the LCS clients or the Application function (AF). In this scenario, it is assumed that the target UE (which may be a remote UE) may be identified using an SUPI or GPSI. This procedure is applicable to a request from an LCS client or AF for a current location of the target UE, and it is assumed that
Privacy verification may be required for the location service request;
The LCS client or the AF needs to be authorised to use the location service.
[ . . . ] In step 1301. The LCS Client or the AF (via Network Exposure Function (NEF) sends a request to the (H) GMLC for a location and optionally a velocity for the target UE which may be identified by an GPSI or an SUPI. The request may include the required QoS, supported GAD shapes and other attributes. (H) GMLC (for 1a) or NEF (for 1b) authorizes the LCS Client or the AF for the usage of the LCS service. If the authorization fails, steps 1302-1323 may be skipped and (H) GMLC (for 1a) or NEF (for 1b) responds to the LCS Client or the AF the failure of the service authorization in step 1324. In some cases, the (H) GMLC derives the GPSI or SUPI of the target UE and possibly the QoS from either subscription data or other data supplied by the LCS Client or AF.
The LCS request may carry also the Service Identity (see TS 22.071 v17.0.0) and the Codeword and the service coverage information. The (H) GMLC may verify that the Service Identity received in the LCS request matches one of the service identities allowed for the LCS client or AF. If the service identity does not match one of the service identities for the LCS client or AF, the (H) GMLC shall reject the LCS request. Otherwise, the (H) GMLC can map the received service identity in a corresponding service type.
The LCS service request may include a scheduled location time if a current location of the UE is required at a specific time in the future.
If the LCS service request contains the pseudonym of the target UE and the (H) GMLC cannot resolve the PMD address from the pseudonym, the (H) GMLC itself determines the verinym (GPSI or SUPI) of the target UE. If the (H) GMLC can resolve the address of PMD from the pseudonym, the HGMLC requests the verinym from its associated PMD. If (H) GMLC is not able to obtain the verinym of the target UE, the (H) GMLC shall cancel the location request.
If a scheduled location time is not included and the requested type of location is “current or last known location” and the requested maximum age of location information is available, the (H) GMLC verifies whether it stores the previously obtained location estimate of the target UE. If the HGMLC stores the location estimate and timestamp of the location estimate (if available) and the location estimate satisfies the requested accuracy and the requested maximum age of location, the (H) GMLC checks the result of the privacy check at step 1302. If the result of the privacy check for call/session unrelated class is “Location allowed without notification” then steps 1303-1323 may be skipped.
Step 1301b-1 AF sends the Nnef_EventExposure_Subscribe to the NEF.
Step 1301b-2 The NEF identifies based on the QoS attribute received from the location request that higher than cell-ID level location accuracy is required and invokes the Ngmlc_Location_ProvideLocation_Request service operation to the (H) GMLC, which contains the attributes received from the AF request. The NEF may also invoke the Ngmlc_Location_ProvideLocation_Request service operation to the (H) GMLC for lower than cell-ID location accuracy as an implementation option or if a scheduled location time is included.
If location is required for more than one UE, the steps following below may be repeated and in that case the NEF or HGMLC receiving location request, shall verify whether the number of Target UEs in the Nnef_EventExposure_Subscribe or LCS request is equal to or less than the Maximum Target UE Number of the LCS client. If Maximum Target UE Number is exceeded, the NEF or HGMLC shall reject the Nnef_EventExposure_Subscribe or LCS request, the steps 1302-1323 are skipped, and then GMLC respond to the client with proper error cause in the step 1324.
NOTE 1: If cell-ID level or lower than cell-ID level location accuracy is required in the location request, the NEF may invoke an Namf_EventExposure_Subscribe service operation to subscribe location event reporting from the AMF for the target UE as further described in clause 6.5.
Step 1302. The (H) GMLC invokes a Nudm_SDM_Get service operation towards the UDM of the target UE to get the privacy settings of the UE identified by its GPSI or SUPI. The UDM returns the target UE Privacy setting of the UE. The (H) GMLC checks the UE LCS privacy profile. If the target UE is not allowed to be located, steps 1303-1323 are skipped.
Step 1303. The (H) GMLC invokes a Nudm_UECM_Get service operation towards the UDM of the target UE with GPSI or SUPI of this UE. The UDM returns the network addresses of the current serving AMF and additionally the address of a VGMLC (for roaming case). If the location request is an immediate location request, the (H) GMLC checks the country codes of the serving node addresses. If the (H) GMLC finds the current AMF is out of the service coverage of the (H) GMLC, the (H) GMLC returns an appropriate error message to the LCS client or AF (via NEF).
NOTE 2: The UDM is aware of the serving AMF address at UE registration on an AMF as defined in clause 4.2.2.2.2 of TS 23.502 v17.6.0. The UDM is aware of a serving VGMLC address at UE registration on an AMF as defined in clause 4.2.2.2.2 of TS 23.502 v17.6.0.
NOTE 3: The HGMLC can also query the HSS of the target UE for a serving MME address as described in clause 9.1.1 of TS 23.271 v17.0.0. The EPC-MT-LR procedure described in clause 9.1.15 of TS 23.271 v17.0.0, excluding the UE availability event, may then be performed instead of steps 1304-1323, e.g. if the HSS returns an MME address but the UDM does not return an AMF address.
Step 1304. For a non-roaming case, this step is skipped. In the case of roaming, the HGMLC may receive an address of a VGMLC (together with the network address of the current serving AMF) from the UDM in step 1303, otherwise, the HGMLC may use the NRF service in the HPLMN to select an available VGMLC in the VPLMN, based on the VPLMN identification contained in the AMF address received in step 1303. The HGMLC then sends the location request to the VGMLC by invoking the Ngmlc_Location_ProvideLocation service operation towards the VGMLC. In the cases when the HGMLC did not receive the address of the VGMLC, or when the VGMLC address is the same as the HGMLC address, or when both PLMN operators agree, the HGMLC sends the location service request message to the serving AMF. In this case, step 1304 is skipped. If the result of privacy check indicates that the verification based on current location is needed, the HGMLC shall send a location request to the VGMLC (in the case of roaming) or to the AMF (in the case of non-roaming) indicating “positioning allowed without notification” and VGMLC shall invoke an Namf_Location_ProvidePositioningInfo Request service operation towards the AMF at step 1305. H-GMLC also provides the LCS client type of AF, if received in step 1301b-2, or LCS client type of LCS client and other attributes to be sent to AMF in step 1305.
Step 1305. In the case of roaming, the VGMLC first authorizes that the location request is allowed from this HGMLC, PLMN or from this country. If not, an error response is returned. The (H) GMLC or VGMLC invokes the Namf_Location_ProvidePositioningInfo service operation towards the AMF to request the current location of the UE. The service operation includes the SUPI, the client type and may include the required LCS QoS, supported GAD shapes, scheduled location time, service type and other attributes as received or determined in step 1301. {Step 1305 corresponds to steps 802 of FIGS. 8 and 1002 of FIG. 10.}
NOTE 4: The location request forwarded at step 1304 and step 1305 may also carry the result of the privacy check in step 1302 which may include a codeword provided by the LCS Client or AF and an indication of a privacy related action as described in clause 5.4.
Step 1306. If the UE is in CM IDLE state, the AMF initiates a network triggered Service Request procedure as defined in clause 4.2.3.3 of TS 23.502 v17.6.0 to establish a signalling connection with the UE.
   If signalling connection establishment fails, steps 1307-1313 are skipped and the AMF answers to the GMLC in step 1314 with the last known location of the UE (i.e. Cell ID) together with the age of this location.
Step 1307. If the indicator of privacy check related action indicates that the UE must either be notified or notified with privacy verification and if the UE supports LCS notification (according to the UE capability information), a notification invoke message is sent to the target UE, indicating the identity of the LCS client and the service type (if that is both supported and available) and whether privacy verification is required.
Step 1308. The target UE notifies the UE user of the location request and, if privacy verification was requested, waits for the user to grant or withhold permission. The UE then returns a notification result to the AMF indicating, if privacy verification was requested, whether permission is granted or denied for the current LCS request. If the UE user does not respond after a predetermined time period, the AMF shall infer a “no response” condition. The AMF shall return an error response in step 1314 and if roaming VGMLC in step 1315 to the HGMLC if privacy verification was requested and either the UE user denies permission or there is no response with the indication received from the (H) GMLC indicating barring of the location request and steps 1310-1313 are skipped.
   The notification result may also indicate the Location Privacy Indication setting for subsequent LCS requests; i.e whether subsequent LCS requests, if generated, will be allowed or disallowed by the UE. The Location Privacy Indication may also indicate a time for disallowing the subsequent LCS requests.
Step 1309. The AMF invokes the Nudm_ParameterProvision_Update (LCS privacy) service operation to store in the UDM the Location Privacy Indication information received from the UE. The UDM may then store the updated UE privacy setting information into the UDR as the “LCS privacy” Data Subset of the Subscription Data.
Steps 1310-1313. Steps 1310-1313 are the same as steps 1206-1209 defined with reference to FIG. 12 above with the addition that service type may be indicated towards the LMF and the exception that the LMF may determine the UE location in local coordinates or geographical co-ordinates or both. If the supported GAD shapes is not received in step 1311 or Local Co-ordinates is not included in the supported GAD shapes, the LMF may determine a geographical location. If a scheduled location time is provided at step 1305, steps 1311 and 1312 include the following additional differences. If AMF has the information that the UE is connecting to the network via a relay UE, it should include the info in the Nimf_Location_DetermineLocation request to the LMF.
Step 1311. The AMF may include the scheduled location time in the Nimf_Location_DetermineLocation service operation sent towards the LMF. {Step 1311 corresponds to step 902 of FIG. 9.}
Step 1312. When sending a location request to the UE, the LMF may include the scheduled location time.
NOTE 5: LMF may not deliver the scheduled location time to NG-RAN as part of step 1312.
NOTE 6: The LMF may send a location request to the UE at step 1312 containing the scheduled location time sometime before the scheduled location time to allow the UE to enter CM Connected state shortly before the scheduled location time.

### NOTE x: LMF May Consider During Positioning UE is Remote UE or not.

Step 1314. The AMF returns the Namf_Location_ProvidePositioningInfo Response towards the (V) GMLC (or HGMLC for roaming when the NL3 reference point is not supported) to return the current location of the UE. The service operation includes the location estimate, its age and accuracy and may include information about the positioning method and the timestamp of the location estimate and if UE is remote UE. {Step 1314 corresponds to step 804 of FIG. 8 and step 1004 of FIG. 10.}
Note: The remote UE may also have a serving cell which is same as the relay UE. In case if a relay UE has been determined and the AMF knows the cellID of relay UE. The cell ID and additional information on extended area (such as zones), maximum relay distance are also returned to GMLC. In such cases, the GMLC may consider that the cell is extended implying that the area size could be large with large uncertainty. Either GMLC or LCS client can resolve cellID+relay extension and convert it to GAD shape.
Step 1315. In the case of roaming, the VGMLC forwards the location estimation of the target UE, its age, its accuracy and optionally the information about the positioning method received at step 1314 to the HGMLC. For non-roaming scenario, this step is skipped.
Step 1316. If the privacy check in step 1302 indicates that further privacy checks are needed, the (H) GMLC shall perform an additional privacy check in order to decide whether the (H) GMLC can forward the location information to the LCS client or AF or send a notification if the result of the privacy check requires the notification and verification based on current location. One example when this additional privacy check is needed is when the target UE user has defined different privacy settings for different geographical locations. When an additional privacy check is not needed, the (H) GMLC skips steps 1317-1323.
Step 1317. If the result of privacy checks in step 1316 indicates that the notification (and verification) based on current location is needed, and in the case of roaming, the (H) GMLC shall send a location request to the VGMLC with location type indicating “notification only”.
Step 1318. The (H) GMLC or VGMLC invokes the Namf_Location_ProvidePositioningInfo service operation towards the AMF to request notification (and verification) based on current location.
Step 1319. If the UE is in CM IDLE state, the AMF initiates a network triggered Service Request procedure as defined in clause 4.2.3.3 of TS 23.502 v17.6.0 to establish a signalling connection with the UE.
Step 1320. If the indicator of privacy check related action indicates that the UE must either be notified or notified with privacy verification and if the UE supports LCS notification, the AMF sends a notification invoke message to the target UE, indicating the identity of the LCS client and the service type (if that is both supported and available) and whether privacy verification is required.
Step 1321. Step 1321 is the same as step 1308.
Step 1322. The AMF returns the Namf_Location_ProvidePositioningInfo Response towards the (V) GMLC (or HGMLC for roaming when the NL3 reference point is not supported) with an indication of the result of notification and verification procedure performed in steps 1320-1321.
Step 1323. In the case of roaming, the VGMLC forwards an indication of the result of notification and verification procedure to the HGMLC. For non-roaming scenario, this step is skipped.
Step 1324. The (H) GMLC sends the location service response to the LCS Client or AF (via the NEF) if the target UE is allowed to be located by the LCS Client or AF. Accordingly, NEF invokes Nnef_EventExposure_Notify or sends Nnef_EventExposure_Subscribe Response to the AF. If the location request from the LCS Client contained the pseudonym and the (H) GMLC resolved the verinym from the pseudonym in step 1, the (H) GMLC shall use the pseudonym of the target UE in the location response to the external LCS client. If the external LCS client or AF requires it, the (H) GMLC may first transform the universal location co-ordinates provided by the AMF into some local geographic reference system. The (H) GMLC may record charging information both for the LCS Client or AF and inter-network revenue charges from the AMF's network. The location service response from the (H) GMLC to the LCS Client or AF may contain the information about the positioning method used and the indication whether the obtained location estimate satisfies the requested accuracy or not. If in step 1302, step 1315, step 1316 or step 1323 the (H) GMLC identifies that the target UE is not allowed to be located by the LCS Client or AF, it rejects the LCS service request, and optionally indicate in the response the reason of the rejection, i.e. the target UE is not allowed to be located. If the LCS QoS Class is Assured and (H) GMLC detects that requested accuracy is not achieved, the (H) GMLC sends error response including failure cause.”
The below procedure is taken from stage 3 TS 29.518 v17.7.0 and proposed changes according to embodiments described herein are underlined.

### “Stage 3 Signaling

The below stage 3 changes may be required in TS 29.518 v17.7.0.

### 6.4.6.2.3 Type: ProvidePosInfo

TABLE 6.4.6.2.3-1
Definition of type ProvidePosInfo

| | | | Cardi- | | Applica- |
|---|---|---|---|---|---|
| Attribute name | Data type | P | nality | Description | bility |
| locationEstimate | GeographicArea | O | 0 . . . 1 | If present, this IE shall contain an | |
| | | | | estimate of the location of the UE in | |
| | | | | universal coordinates and the | |
| | | | | accuracy of the estimate. | |
| localLocationEstimate | LocalArea | O | 0 . . . 1 | When present, this IE shall indicate | |
| | | | | a local area in renference system. | |
| accuracyFulfilmentIndicator | AccuracyFulfilmentIndicator | O | 0 . . . 1 | If present, this IE shall contain an | |
| | | | | indication of whether the requested | |
| | | | | accuracy (as indicated in the | |
| | | | | LcsQoS in the request message) | |
| | | | | was fulfilled or not. | |
| ageOfLocationEstimate | AgeOfLocationEstimate | O | 0 . . . 1 | If present, this IE shall contain an | |
| | | | | indication of how long ago the | |
| | | | | location estimate was obtained. | |
| timestampOfLocationEstimate | DateTime | O | 0 . . . 1 | When present, this IE shall indicate | |
| | | | | the estimated UTC time when the | |
| | | | | location estimate corresponded to | |
| | | | | the UE location (i.e. when the | |
| | | | | location estimate and the actual UE | |
| | | | | location was the same). | |
| velocityEstimate | VelocityEstimate | O | 0 . . . 1 | If present, this IE shall contain an | |
| | | | | estimate of the velocity of the target | |
| | | | | UE, composed by horizontal speed, | |
| | | | | vertical speed, and their respective | |
| | | | | uncertainty. | |
| positioningDataList | array(PositioningMethodAndUsage) | O | 0 . . . 9 | If present, this IE shall indicate the | |
| | | | | usage of each non- GANSS | |
| | | | | positioning method that was | |
| | | | | attempted to determine the location | |
| | | | | estimate, either successfully or | |
| | | | | unsuccessfully. | |
| gnssPositioningDataList | array(GnssPositioningMethodAndUsage) | O | 0 . . . 9 | If present, this IE shall indicate the | |
| | | | | usage of each GANSS positioning | |
| | | | | method that was attempted to | |
| | | | | determine the location estimate, | |
| | | | | either successfully or unsuccessfully. | |
| Ecgi | Ecgi | O | 0 . . . 1 | If present, this IE shall contain the | |
| | | | | current EUTRAN cell location of the | |
| | | | | target UE as delivered by the 5G-AN. | |
| Ncgi | Ncgi | O | 0 . . . 1 | If present, this IE shall contain the | |
| | | | | current NR cell location of the target | |
| | | | | UE as delivered by the 5G-AN. | |
| targetServingNode | NfInstanceId | O | 0 . . . 1 | If present, this IE shall contain the | |
| | | | | address of the target side serving | |
| | | | | node for intra-5GS handover of an | |
| | | | | IMS Emergency Call. | |
| targetMmeName | DiameterIdentity | C | 0 . . . 1 | This IE shall be present for handover | |
| | | | | of IMS emergency call to EPS, i.e. | |
| | | | | the target node is an MME. | |
| | | | | When present, this IE shall indicate | |
| | | | | the Diameter host name of the target | |
| | | | | MME. | |
| targetMmeRealm | DiameterIdentity | C | 0 . . . 1 | This IE shall be present for handover | |
| | | | | of IMS emergency call to EPS, i.e. | |
| | | | | the target node is an MME. | |
| | | | | When present, this IE shall indicate | |
| | | | | the Diameter realm of the target | |
| | | | | MME. | |
| utranSrvccInd | boolean | C | 0 . . . 1 | This IE shall be present with value | |
| | | | | “true” for 5G-SRVCC to 3GPP | |
| | | | | UTRAN of IMS emergency call, i.e. | |
| | | | | target node is an MSC. | |
| | | | | When present, this IE shall be set for | |
| | | | | the following value: | |
| | | | | true: IMS emergency call | |
| | | | | handover to UTRAN | |
| | | | | false: No IMS emergency call | |
| | | | | handover to UTRAN | |
| civicAddress | CivicAddress | O | 0 . . . 1 | If present, this IE contains a location | |
| | | | | estimate for the target UE expressed | |
| | | | | as a Civic address. | |
| barometricPressure | BarometricPressure | O | 0 . . . 1 | If present, this IE contains the | |
| | | | | barometric pressure measurement | |
| | | | | as reported by the target UE. | |
| Altitude | Altitude | O | 0 . . . 1 | If present, this IE indicates the | |
| | | | | altitude of the positioning estimate. | |
| supportedFeatures | SupportedFeatures | C | 0 . . . 1 | This IE shall be present if at least | |
| | | | | one optional feature defined in | |
| | | | | clause 6.4.8 is supported. | |
| servingLMFIdentification | LMFIdentification | O | 0 . . . 1 | If present, this IE contains the | |
| | | | | identification of a serving LMF for | |
| | | | | periodic or triggered location | |
| locationPrivacyVerResult | LocationPrivacyVerResult | O | 0 . . . 1 | If present, this IE contains the result | |
| | | | | of location privacy verification by UE | |
| | | | | (NOTE) | |
| achievedQos | MinorLocationQoS | C | 0 . . . 1 | When present, this IE shall contain | MUTIQOS |
| | | | | the achieved Location QoS Accuracy | |
| | | | | of the estimated location. | |
| | | | | This IE shall be present if received | |
| | | | | from LMF. | |
| remoteUE | boolean | O | 0 . . . 1 | If present, this IE informs whether | |
| | | | | the UE is remote UE or not | |
| | | | | When present, this IE shall be set | |
| | | | | for the following value: | |
| | | | | true: Remote UE | |
| | | | | false: Not a remote UE | |
| remoteUELocationEstimate | ZoneArea | O | 0 . . . 1 | When present, this IE shall indicate | |
| | | | | a Zone area in renference system. | |
| maxRelayCoverage/Distance | RelayDistance | O | 0 . . . 1 | When present, this IE shall indicate | |
| | | | | Maximum relay distance covergae | |

(NOTE):
The IE may be included to indicate the result of location privacy verification by UE to (H)GMLC when a location request with notification and privacy verification only indication is sent to the serving AMF by (H)GMLC during location request procedure.

FIG. 14 shows an example of a communication system 1400 in accordance with some embodiments.

In the example, the communication system 1400 includes a telecommunication network 1402 that includes an access network 1404, such as a radio access network (RAN), and a core network 1406, which includes one or more core network nodes 1408. The access network 1404 includes one or more access network nodes, such as network nodes 1410a and 1410b (one or more of which may be generally referred to as network nodes 1410), or any other similar 3^{rd} Generation Partnership Project (3GPP) access node or non-3GPP access point. The network nodes 1410 facilitate direct or indirect connection of user equipment (UE), such as by connecting UEs 1412a, 1412b, 1412c, and 1412d (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF) and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 14, the hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, a content source and analytics node, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

FIG. 15 shows a UE 1500 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3^{rd} Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, a memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1502 may include multiple central processing units (CPUs). The processing circuitry 1502 may be operable to provide, either alone or in conjunction with other UE 1500 components, such as the memory 1510, UE 1500 functionality. For example, the processing circuitry 1502 may be configured to cause the UE 1502 to perform the methods as described with reference to FIG. 6.

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging of the power source 1508. Power circuitry may perform any formatting, converting, or other modification to the power from the power source 1508 to make the power suitable for the respective components of the UE 1500 to which power is supplied.

The memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1510 may allow the UE 1500 to access instructions, application programs and the like, stored on transitory or non-transitory memory media, to off-load data, or to upload data. An article of manufacture, such as one utilizing a communication system may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., antenna 1522) and may share circuit components, software or firmware, or alternatively be implemented separately.

In some embodiments, communication functions of the communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 1500 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 16 shows a network node 1600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs), and/or Minimization of Drive Tests (MDTs).

The network node 1600 includes processing circuitry 1602, a memory 1604, a communication interface 1606, and a power source 1608, and/or any other component, or any combination thereof. The network node 1600 may be composed of multiple physically separate components (e.g., a NodeB component and a RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as the memory 1604, network node 1600 functionality. For example, the processing circuitry 1602 may be configured to cause the network node to perform the methods as described with reference to FIG. 7.

In some embodiments, the processing circuitry 1602 includes a system on a chip (SOC). In some embodiments, the processing circuitry 1602 includes one or more of radio frequency (RF) transceiver circuitry 1612 and baseband processing circuitry 1614. In some embodiments, the radio frequency (RF) transceiver circuitry 1612 and the baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

The memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. Radio front-end circuitry 1618 comprises filters 1620 and amplifiers 1622. The radio front-end circuitry 1618 may be connected to an antenna 1610 and processing circuitry 1602. The radio front-end circuitry may be configured to condition signals communicated between antenna 1610 and processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of filters 1620 and/or amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface may comprise different components and/or different combinations of components.

In certain alternative embodiments, the network node 1600 does not include separate radio front-end circuitry 1618, instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes one or more ports or terminals 1616, the radio front-end circuitry 1618, and the RF transceiver circuitry 1612, as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, communication interface 1606, and/or the processing circuitry 1602 may be configured to perform any receiving operations and/or certain obtaining operations described herein as being performed by the network node. Any information, data and/or signals may be received from a UE, another network node and/or any other network equipment. Similarly, the antenna 1610, the communication interface 1606, and/or the processing circuitry 1602 may be configured to perform any transmitting operations described herein as being performed by the network node. Any information, data and/or signals may be transmitted to a UE, another network node and/or any other network equipment.

The power source 1608 provides power to the various components of network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid, an electricity outlet) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

FIG. 20 shows a network node 2000 in accordance with some embodiments. As used herein, network node refers to equipment capable, configured, arranged and/or operable to communicate directly or indirectly with a UE and/or with other network nodes or equipment, in a telecommunication network. The network node 2000 may be operable as a core network node, a core network function or, more generally, a core network entity, such as the core network node 1408 described above with respect to FIG. 14). Examples of network nodes in this context include core network entities such as one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Policy Control Function (PCF) and/or a User Plane Function (UPF).

The network node 2000 includes processing circuitry 2002, a memory 2004, a communication interface 2006, and a power source 2008, and/or any other component, or any combination thereof. The network node 2000 may be composed of multiple physically separate components, which may each have their own respective components. In certain scenarios in which the network node 2000 comprises multiple separate components, one or more of the separate components may be shared among several network nodes.

The processing circuitry 2002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2000 components, such as the memory 2004, network node 2000 functionality. For example, the processing circuitry 2002 may be configured to cause the network node to perform the methods as described with reference to Figure VV3, 9 or 10.

The memory 2004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2002. The memory 2004 may store any suitable instructions, data, or information, including a computer program, software, an application including one or more of logic, rules, code, tables, and/or other instructions capable of being executed by the processing circuitry 2002 and utilized by the network node 2000. The memory 2004 may be used to store any calculations made by the processing circuitry 2002 and/or any data received via the communication interface 2006. In some embodiments, the processing circuitry 2002 and memory 2004 is integrated.

The communication interface 2006 is used in wired or wireless communication of signaling and/or data between a network node, access network, and/or UE.

The power source 2008 provides power to the various components of network node 2000 in a form suitable for the respective components (e.g., at a voltage and current level needed for each respective component). The power source 2008 may further comprise, or be coupled to, power management circuitry to supply the components of the network node 2000 with power for performing the functionality described herein. For example, the network node 2000 may be connectable to an external power source (e.g., the power grid, an electricity outlet) via an input circuitry or interface such as an electrical cable, whereby the external power source supplies power to power circuitry of the power source 2008. As a further example, the power source 2008 may comprise a source of power in the form of a battery or battery pack which is connected to, or integrated in, power circuitry. The battery may provide backup power should the external power source fail.

Embodiments of the network node 2000 may include additional components beyond those shown in FIG. 20 for providing certain aspects of the network node's functionality, including any of the functionality described herein and/or any functionality necessary to support the subject matter described herein. For example, the network node 2000 may include user interface equipment to allow input of information into the network node 2000 and to allow output of information from the network node 2000. This may allow a user to perform diagnostic, maintenance, repair, and other administrative functions for the network node 2000.

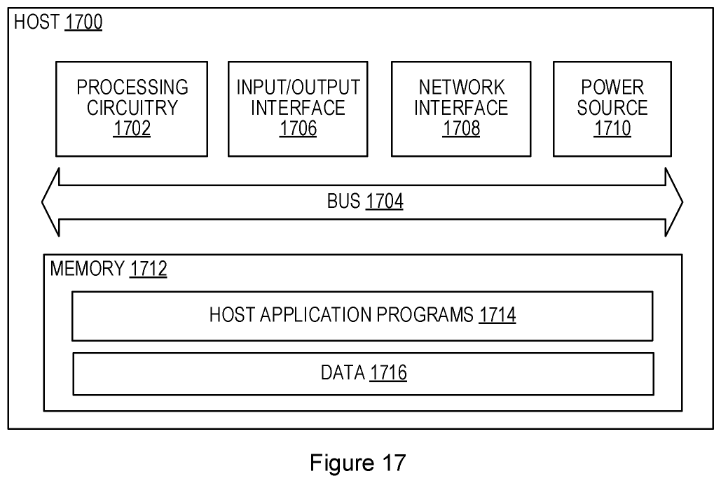

FIG. 17 is a block diagram of a host 1700, which may be an embodiment of the host 1416 of FIG. 14, in accordance with various aspects described herein. As used herein, the host 1700 may be or comprise various combinations hardware and/or software, including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and a memory 1712. Other components may be included in other embodiments. Features of these components may be substantially similar to those described with respect to the devices of previous figures, such as FIGS. 15 and 16, such that the descriptions thereof are generally applicable to the corresponding components of host 1700.

The memory 1712 may include one or more computer programs including one or more host application programs 1714 and data 1716, which may include user data, e.g., data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (WVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for over-the-top services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

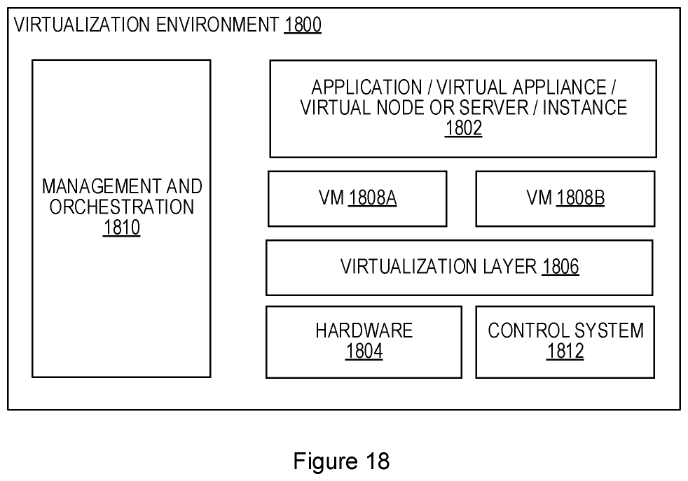

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a and 1808b (one or more of which may be generally referred to as VMs 1808), and/or perform any of the functions, features and/or benefits described in relation with some embodiments described herein. The virtualization layer 1806 may present a virtual operating platform that appears like networking hardware to the VMs 1808.

The VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1808 may be a software implementation of a physical machine that runs programs as if they were executing on a physical, non-virtualized machine. Each of the VMs 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of the hardware 1804 and corresponds to the application 1802.

Hardware 1804 may be implemented in a standalone network node with generic or specific components. Hardware 1804 may implement some functions via virtualization. Alternatively, hardware 1804 may be part of a larger cluster of hardware (e.g. such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

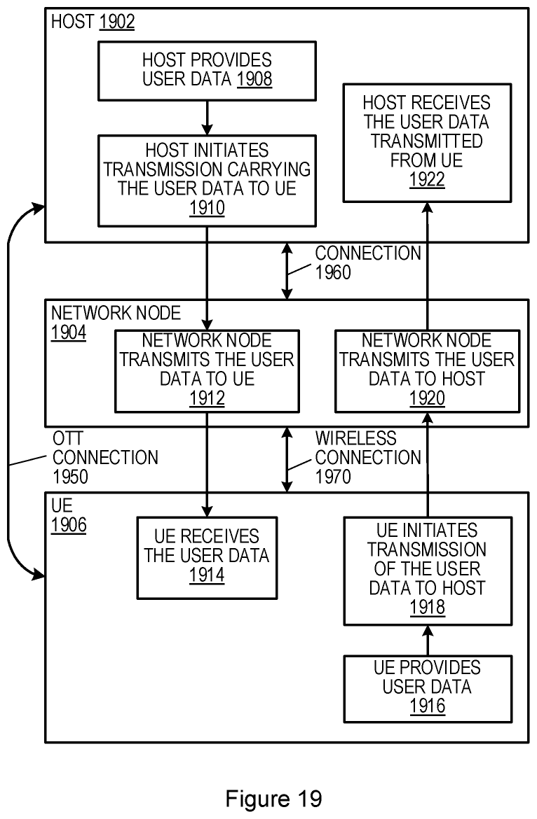

FIG. 19 shows a communication diagram of a host 1902 communicating via a network node 1904 with a UE 1906 over a partially wireless connection in accordance with some embodiments. Example implementations, in accordance with various embodiments, of the UE (such as a UE 1412a of FIG. 14 and/or UE 1500 of FIG. 15), network node (such as network node 1410a of FIG. 14 and/or network node 1600 of FIG. 16), and host (such as host 1416 of FIG. 14 and/or host 1700 of FIG. 17) discussed in the preceding paragraphs will now be described with reference to FIG. 19.

Like host 1700, embodiments of host 1902 include hardware, such as a communication interface, processing circuitry, and memory. The host 1902 also includes software, which is stored in or accessible by the host 1902 and executable by the processing circuitry. The software includes a host application that may be operable to provide a service to a remote user, such as the UE 1906 connecting via an over-the-top (OTT) connection 1950 extending between the UE 1906 and host 1902. In providing the service to the remote user, a host application may provide user data which is transmitted using the OTT connection 1950.

The network node 1904 includes hardware enabling it to communicate with the host 1902 and UE 1906. The connection 1960 may be direct or pass through a core network (like core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of the host 1902. In the host 1902, an executing host application may communicate with the executing client application via the OTT connection 1950 terminating at the UE 1906 and host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via a connection 1960 between the host 1902 and the network node 1904 and via a wireless connection 1970 between the network node 1904 and the UE 1906 to provide the connection between the host 1902 and the UE 1906. The connection 1960 and wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904, in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

One or more of the various embodiments improve the performance of OTT services provided to the UE 1906 using the OTT connection 1950, in which the wireless connection 1970 forms the last segment. More precisely, the teachings of these embodiments may improve the location estimate for a user equipment.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR or AR which it can broadcast, multicast or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1950 between the host 1902 and UE 1906, in response to variations in the measurement results. The measurement procedure and/or the network functionality for reconfiguring the OTT connection may be implemented in software and hardware of the host 1902 and/or UE 1906. In some embodiments, sensors (not shown) may be deployed in or in association with other devices through which the OTT connection 1950 passes; the sensors may participate in the measurement procedure by supplying values of the monitored quantities exemplified above, or supplying values of other physical quantities from which software may compute or estimate the monitored quantities. The reconfiguring of the OTT connection 1950 may include message format, retransmission settings, preferred routing etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency and the like, by the host 1902. The measurements may be implemented in that software causes messages to be transmitted, in particular empty or ‘dummy’ messages, using the OTT connection 1950 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EMBODIMENTS

### Group C Embodiments

1. A method performed by an Access and Mobility Management Function, AMF, for assisting in determining positioning of a remote user equipment, UE that is communicating with a network via sidelink, SL, communication with a relay UE, the method comprising:
   receiving a first request for positioning information associated with the remote UE from a Gateway Mobile Location Centre, GMLC; and
   transmitting a first response to the first request, wherein the first response comprises: an indication of a location of the remote UE to the GMLC, and an indication that the remote UE is connecting to the network via the relay UE.
2. The method of embodiment 1 wherein the method further comprises:
   responsive to receiving the first request for positioning information, transmitting, to a location management function, LMF, a second request for an indication of a location of the remote UE, wherein the second request comprises an indication that the remote UE is connecting to the network via the relay UE.
3. The method of embodiment 2 further comprising:
   responsive to transmitting the second request, receiving the indication of the location of the remote UE.
4. The method of embodiment 1 to 3 further comprising:
   transmitting, to the GMLC, an indication of a cell identification for a serving cell serving the relay UE.
5. The method of embodiment 1 to 4 further comprising transmitting information to the GMLC relating to the sidelink communication between the relay UE and the remote UE.
6. The method of embodiment 6 further comprising receiving the information from a base station in a radio access network.
7. The method of embodiment 5 or 6 wherein the information comprises one or more identifications of one or more sidelink resource pools configured for sidelink transmission and/or reception between the relay UE and the remote UE.
8. The method of embodiment 7 wherein the information further comprises one or more identifications of one or more geographical areas associated with each of the one or more sidelink resource pools.
9. The method of embodiment 5 to 8 wherein the information comprises one or more identifications of one or more geographical areas that have recently been used for SL transmission or reception by the remote UE and the relay UE.
10. The method of embodiment 5 to 9 wherein the information comprises an indication of a maximum coverage distance of the relay UE.
11. An AMF comprising processing circuitry configured to cause the AMF to perform the method as in any one of embodiments 1 to 10.
12. A method performed by a Location Management Function, LMF, for assisting in determining positioning of a remote user equipment, UE that is communicating with a network via sidelink, SL, communication with a relay UE, the method comprising:
   receiving a second request, from an Access and Mobility Management Function, AMF, for an indication of a location of the remote UE, wherein the second request comprises an indication that the remote UE is connecting to the network via the relay UE.
13. The method of embodiment 12 wherein the LMF performs positioning of the remote UE based on the indication that the remote UE is connecting to the network via the relay UE to estimate a location of the remote UE.
14. The method of embodiment 13 further comprising: transmitting an indication of the estimate of the location of the remote UE to the AMF.
15. The method of embodiments 12 to 14 further comprising receiving information, from the AMF, relating to the sidelink communication between the relay UE and the remote UE.
16. A Location Management Function comprising processing circuitry configured to cause the LMF to perform the method as in any one of embodiments 12 to 15.
17. A method performed by a Gateway Mobile Location Centre, GMLC, for assisting in determining positioning of a remote user equipment, UE that is communicating with a network via sidelink, SL, communication with a relay UE, the method comprising:
   transmitting a first request for positioning information associated with the remote UE from a Gateway to an Access and Mobility Management Function, AMF; and
   receiving a first response to the first request, wherein the first response comprises: an indication of a location of the remote UE to the GMLC, and an indication that the remote UE is connecting to the network via the relay UE.
18. The method of embodiment 17 further comprising:
   receiving an indication of a cell identification for the serving cell serving the relay UE from the AMF.
19. The method of embodiment 17 or 18 further comprising receiving information from the AMF relating to the sidelink communication between the relay UE and the remote UE.
20. The method of embodiment 19 wherein the information comprises one or more identifications of one or more sidelink resource pools configured for sidelink transmission and/or reception between the relay UE and the remote UE.
21. The method of embodiment 20 wherein the information further comprises one or more identifications of one or more geographical areas associated with each of the one or more sidelink resource pools.
22. The method of embodiment 19 to 21 wherein the information comprises one or more identifications of one or more geographical areas that have recently been used for SL transmission or reception by the remote UE and the relay UE.
23. The method of embodiment 19 to 22 wherein the information comprises an indication of a maximum coverage distance of the relay UE.
24. A Gateway Mobile Location Centre, GMLC, comprising processing circuitry configured to cause the GMLC to perform the method as in any one of embodiments 16 to 23.

### Group A Embodiments

25. A method performed by a first user equipment, UE for assisting in determining positioning of a remote user equipment, UE that is communicating with a network via sidelink, SL, communication with a relay UE, wherein the first UE comprises the remote UE or the relay UE, the method comprising:
   transmitting, to a base station, an indication of a cell identification for a serving cell serving the relay UE to assist in positioning of the remote UE.
26. The method of embodiment 24 wherein the first UE comprises the remote UE, and wherein the step of transmitting comprises transmitting the indication to the base station via the relay UE.
27. The method of embodiment 24 wherein the first UE comprises the relay UE.
28. The method as claimed in claims 24 to 26 further comprising transmitting information relating to the sidelink communication between the relay UE and the remote UE to the base station.
29. The method of embodiment 27 wherein the information comprises one or more identifications of one or more sidelink resource pools configured for sidelink transmitting and/or reception between the relay UE and the remote UE.
30. The method of embodiment 28 wherein the information further comprises one or more identifications of one or more geographical areas associated with each of the one or more sidelink resource pools.
31. The method of embodiment 27 to 29 wherein the information one or more identifications of one or more geographical areas that have recently been used for SL transmission or reception.
32. The method of embodiment 27 to 30 wherein the information comprises an indication of a maximum coverage distance of the relay UE.
33. The method of any one of embodiments 27 to 31 wherein the information is received from the remote UE.
34. The method of any of the previous group A embodiments, further comprising:
   providing user data; and
   forwarding the user data to a host via the transmission to the network node.

### Group B Embodiments

35. A method performed by a network node in a network for assisting in determining positioning of a remote user equipment, UE that is communicating with a network via sidelink, SL, communication with a relay UE, the method comprising:
   receiving, from a first UE, an indication of a cell identification for a serving cell serving the relay UE to assist in positioning of the remote UE.
36. The method of embodiment 34 wherein the first UE comprises the remote UE, and wherein the step of receiving comprises receiving the indication via the relay UE.
37. The method of embodiment 34 wherein the first UE comprises the relay UE.
38. The method as claimed in claims 34 to 36 further comprising receiving, from the first UE, information relating to the sidelink communication between the relay UE and the remote UE.
39. The method of embodiment 37 wherein the information comprises one or more identifications of one or more sidelink resource pools configured for sidelink transmitting and/or reception between the relay UE and the remote UE.
40. The method of embodiment 38 wherein the information further comprises one or more identifications of one or more geographical areas associated with each of the one or more sidelink resource pools.
41. The method of embodiment 37 to 339 wherein the information one or more identifications of one or more geographical areas that have recently been used for SL transmission or reception.
42. The method of embodiment 37 to 40 wherein the information comprises an indication of a maximum coverage distance of the relay UE.
43. The method of embodiment 37 to 40 further comprising forwarding the information to an Access and Mobility Management Function, AMF.
44. The method of any of the previous embodiments, further comprising:
   obtaining user data; and
   forwarding the user data to a host or a user equipment.

### Group D Embodiments

45. A first user equipment for assisting in determining positioning of a remote user equipment, UE that is communicating with a network via sidelink, SL, communication with a relay UE, wherein the first UE comprises the remote UE or the relay UE, and wherein the first UE comprises:
   processing circuitry configured to cause the user equipment to perform any of the steps of any of the Group A embodiments; and
   power supply circuitry configured to supply power to the processing circuitry.
46. A network node for assisting in determining positioning of a remote user equipment, UE that is communicating with a network via sidelink, SL, communication with a relay UE, the network node comprising:
   processing circuitry configured to cause the network node to perform any of the steps of any of the Group B embodiments;
   power supply circuitry configured to supply power to the processing circuitry.
47. A core network node for assisting in determining positioning of a remote user equipment, UE that is communicating with a network via sidelink, SL, communication with a relay UE, the core network node comprising:
   processing circuitry configured to cause the network node to perform any of the steps of any of the Group C embodiments;
   power supply circuitry configured to supply power to the processing circuitry.
48. A first user equipment (UE) for assisting in determining positioning of a remote user equipment, UE that is communicating with a network via sidelink, SL, communication with a relay UE, wherein the first UE comprises the remote UE or the relay UE, the first UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the first UE to be processed by the processing circuitry;
   an output interface connected to the processing circuitry and configured to output information from the first UE that has been processed by the processing circuitry; and
   a battery connected to the processing circuitry and configured to supply power to the first UE.
49. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
50. The host of the previous embodiment, wherein the cellular network further includes a network node configured to communicate with the UE to transmit the user data to the UE from the host.
51. The host of the previous 2 embodiments, wherein:
   the processing circuitry of the host is configured to execute a host application, thereby providing the user data; and
   the host application is configured to interact with a client application executing on the UE, the client application being associated with the host application.
52. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
53. The method of the previous embodiment, further comprising:
   at the host, executing a host application associated with a client application executing on the UE to receive the user data from the UE.
54. The method of the previous embodiment, further comprising:
   at the host, transmitting input data to the client application executing on the UE, the input data being provided by executing the host application, wherein the user data is provided by the client application in response to the input data from the host application.
55. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
56. The host of the previous embodiment, wherein the cellular network further includes a network node configured to communicate with the UE to transmit the user data from the UE to the host.
57. The host of the previous 2 embodiments, wherein:
   the processing circuitry of the host is configured to execute a host application, thereby providing the user data; and
   the host application is configured to interact with a client application executing on the UE, the client application being associated with the host application.
58. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
59. The method of the previous embodiment, further comprising:
   at the host, executing a host application associated with a client application executing on the UE to receive the user data from the UE.
60. The method of the previous embodiment, further comprising:
   at the host, transmitting input data to the client application executing on the UE, the input data being provided by executing the host application,
   wherein the user data is provided by the client application in response to the input data from the host application.
61. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
62. The host of the previous embodiment, wherein:
   the processing circuitry of the host is configured to execute a host application that provides the user data; and
   the UE comprises processing circuitry configured to execute a client application associated with the host application to receive the transmission of user data from the host.
63. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
64. The method of the previous embodiment, further comprising, at the network node, transmitting the user data provided by the host for the UE.
65. The method of any of the previous 2 embodiments, wherein the user data is provided at the host by executing a host application that interacts with a client application executing on the UE, the client application being associated with the host application.
66. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
67. The communication system of the previous embodiment, further comprising:
   the network node; and/or
   the user equipment.
68. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
69. The host of the previous embodiment, wherein:
   the processing circuitry of the host is configured to execute a host application, thereby providing the user data; and
   the host application is configured to interact with a client application executing on the UE, the client application being associated with the host application.
70. The host of the any of the previous 2 embodiments, wherein the initiating receipt of the user data comprises requesting the user data.
71. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
72. The method of the previous embodiment, further comprising at the network node, transmitting the received user data to the host.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1× Radio Transmission Technology
3GPP 3rd Generation Partnership Project
5G 5th Generation
6G 6th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
eMBMS evolved Multimedia Broadcast Multicast Services
E-SMLC Evolved-Serving Mobile Location Centre
ECGI Evolved CGI
eNB E-UTRAN NodeB
ePDCCH Enhanced Physical Downlink Control Channel
E-SMLC Evolved Serving Mobile Location Center
E-UTRA Evolved UTRA
E-UTRAN Evolved UTRAN
FDD Frequency Division Duplex
FFS For Further Study
gNB Base station in NR
GNSS Global Navigation Satellite System
HARQ Hybrid Automatic Repeat Request
HO Handover
HSPA High Speed Packet Access
HRPD High Rate Packet Data
LOS Line of Sight
LPP LTE Positioning Protocol
LTE Long-Term Evolution
MAC Medium Access Control
MAC Message Authentication Code
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NPDCCH Narrowband Physical Downlink Control Channel
NR New Radio
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDCP Packet Data Convergence Protocol
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RACH Random Access Channel
QAM Quadrature Amplitude Modulation
RAN Radio Access Network
RAT Radio Access Technology
RLC Radio Link Control
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDAP Service Data Adaptation Protocol
SDU Service Data Unit
SFN System Frame Number
SGW Serving Gateway
SI System Information
SIB System Information Block
SNR Signal to Noise Ratio
SON Self Optimized Network
SS Synchronization Signal
SSS Secondary Synchronization Signal
TDD Time Division Duplex
TDOA Time Difference of Arrival
TOA Time of Arrival
TSS Tertiary Synchronization Signal
TTI Transmission Time Interval
UE User Equipment
UL Uplink
USIM Universal Subscriber Identity Module
UTDOA Uplink Time Difference of Arrival
WCDMA Wide CDMA
WLAN Wide Local Area Network

1-88. (canceled)

89. A method performed by an Access and Mobility Management Function (AMF) for assisting in determining positioning of a remote user equipment (UE) that is communicating with a network via sidelink (SL) communication with a relay UE, the method comprising:
receiving a first request for positioning information associated with the remote UE from a Gateway Mobile Location Centre (GMLC); and
transmitting a first response to the first request, wherein the first response comprises: an indication of a location of the remote UE to the GMLC, an indication that the UE is a remote UE, and a cell/location identifier of the relay UE.

90. The method of claim 89, wherein the method further comprises:
responsive to receiving the first request for positioning information, transmitting, to a location management function (LMF) a second request for an indication of a location of the remote UE, wherein the second request comprises an indication that the UE is a remote UE.

91. The method of claim 90, further comprising, responsive to transmitting the second request, receiving the indication of the location of the remote UE.

92. The method of claim 89, further comprising transmitting information to the GMLC relating to the sidelink communication between the relay UE and the remote UE, wherein the information comprises one or more of:
one or more identifications of one or more sidelink resource pools configured for sidelink transmission and/or reception between the relay UE and the remote UE;
one or more identifications of one or more geographical areas that have recently been used for SL transmission or reception by the remote UE and the relay UE;
an indication of a maximum coverage distance of the relay UE.

93. The method of claim 92, further comprising receiving the information from a base station in a radio access network.

94. The method of claim 92, wherein the information further comprises one or more identifications of one or more geographical areas associated with each of the one or more sidelink resource pools.

95. A method performed by a Gateway Mobile Location Centre (GMLC) for assisting in determining positioning of a remote user equipment (UE) that is communicating with a network via sidelink (SL) communication with a relay UE, the method comprising:
transmitting a first request for positioning information associated with the remote UE from a Gateway to an Access and Mobility Management Function (AMF); and
receiving a first response to the first request, wherein the first response comprises: an indication of a location of the remote UE to the GMLC, an indication that the UE is a remote UE, and a cell/location identifier of the relay UE.

96. The method of claim 95, further comprising receiving information from the AMF relating to the sidelink communication between the relay UE and the remote UE, wherein the information comprises one or more of:
one or more identifications of one or more sidelink resource pools configured for sidelink transmission and/or reception between the relay UE and the remote UE;
one or more identifications of one or more geographical areas that have recently been used for SL transmission or reception by the remote UE and the relay UE;
an indication of a maximum coverage distance of the relay UE.

97. The method of claim 95, wherein the information further comprises one or more identifications of one or more geographical areas associated with each of the one or more sidelink resource pools.

98. A method performed by a Location Management Function (LMF) for assisting in determining positioning of a user equipment (UE) that is communicating with a network via sidelink (SL) communication with a relay UE, the method comprising:
receiving a second request, from an Access and Mobility Management Function (AMF) for an indication of a location of the remote UE, wherein the second request comprises an indication that the UE is a remote UE.

99. The method of claim 98, wherein the LMF performs positioning of the remote UE based on the indication that the remote UE is connecting to the network via the relay UE to estimate a location of the remote UE.

100. The method of claim 99, further comprising: transmitting an indication of the estimate of the location of the remote UE to the AMF.

101. The method of claim 98, further comprising receiving information, from the AMF, relating to the sidelink communication between the relay UE and the remote UE.

102. An access and mobility management function (AMF) for assisting in determining positioning of a remote user equipment (UE) when the UE is communicating with a network via sidelink (SL) communication with a relay UE, the AMF comprising processing and a memory, the memory containing instructions executable by the processing circuitry whereby the AMF is operable to:
receive a first request for positioning information associated with the remote UE from a Gateway Mobile Location Centre (GMLC); and
transmit a first response to the first request, wherein the first response comprises: an indication of a location of the remote UE to the GMLC, an indication that the UE is a remote UE and a cell/location identifier of the relay UE.

103. A Location Management Function (LMF) for assisting in determining positioning of a remote user equipment (UE) when the UE is communicating with a network via sidelink (SL) communication with a relay UE, the LMF comprising processing circuitry and a memory, the memory containing instructions executable by the processing circuitry whereby the LMF is operable to:
receive a second request, from an Access and Mobility Management Function (AMF) for an indication of a location of the remote UE, wherein the second request comprises an indication that the UE is a remote UE.

104. A Gateway Mobile Location Centre (GMLC) for assisting in determining positioning of a remote user equipment (UE) when the remote UE is communicating with a network via sidelink (SL) communication with a relay UE, the GMLC comprising processing circuitry and a memory, the memory containing instructions executable by the processing circuitry whereby the GMLC to operable to:
transmit a first request for positioning information associated with the remote UE from a Gateway to an Access and Mobility Management Function (AMF); and
receive a first response to the first request, wherein the first response comprises: an indication of a location of the remote UE to the GMLC, an indication that the UE is a remote UE, and a cell/location identifier of the relay UE.
